(19) United States
(12) Patent Application Publication
(10) Pub. No.: US 2025/0192883 A1
(43) Pub. Date: Jun. 12, 2025

(54) MONITORING APPARATUS AND MONITORING METHOD

(71) Applicant: NIPPON TELEGRAPH AND TELEPHONE CORPORATION, Tokyo (JP)

(72) Inventors: Manabu YOSHINO, Musashino-shi (JP); Kazutaka HARA, Musashino-shi (JP); Shin KANEKO, Musashino-shi (JP)

(73) Assignee: NIPPON TELEGRAPH AND TELEPHONE CORPORATION, Tokyo (JP)

(21) Appl. No.: 18/846,196

(22) PCT Filed: Mar. 14, 2022
(86) PCT No.: PCT/JP2022/011383

§ 371 Date: Sep. 11, 2024

(51) Int. Cl. H04B 10/073; H04Q 11/00

(52) U.S. Cl. CPC H04B 10/0731; H04Q 11/0005

(57) ABSTRACT

A determination unit determines whether non-compliant light that does not satisfy a predetermined criterion is included in multiplexed light passing through a path to be monitored. A restriction unit controls that an optical signal does not flow through the path when the non-compliant light is included in the multiplexed light.

### TECHNICAL FIELD

The present invention relates to a monitoring device (a monitoring apparatus) and a monitoring method.

### BACKGROUND ART

In recent years, there has been a demand for implementation of a transparent low-delay optical access network by a photonic gateway (hereinafter referred to as “PG”) (see, for example, Non Patent Literature 1). A plurality of user devices (CPE: Customer Premises Equipment) is connected to the PG, and a wavelength to be used for each user device is set. Note that, in the following description, when an optical signal flows from a transmission source to a transmission destination, a position relatively close to the transmission source is referred to as a “preceding stage”, and a position relatively close to the transmission destination is referred to as a “subsequent stage”.

### CITATION LIST

### Non Patent Literature

Non Patent Literature 1: “All photonics network no jitsugen ni muketa aratana system architecture (in Japanese) (New System Architecture for Achieving All Photonics Network)”, the Journal of Institute of Electronics, Information and Communication Engineers Vol. 104 No. 5 pp. 471-477, 2021, <URL: https://www.journal.ieice.org/bin/pdf_link.php?fname=k104_5_471&lang=J&year=2021>

### SUMMARY OF INVENTION

### Technical Problem

At least one of light having an unacceptable intensity or light having a wavelength other than a set wavelength is referred to as non-compliant light. In a transparent network, it is necessary to prevent non-compliant light from passing through. The non-compliant light may be input from, for example, a user device that is not under control. However, there is no means for blocking or stopping output of the non-compliant light in the network including the PG. Such a problem is not limited to the network with the PG, but is a problem common to the entire transparent network.

In view of the above circumstances, an object of the present invention is to provide a technology capable of blocking or stopping output of non-compliant light in a transparent network.

### Solution to Problem

One aspect of the present invention is a monitoring device that monitors a path through which multiplexed light in which light output from a plurality of devices is multiplexed flows, the monitoring device including a determination unit that determines whether non-compliant light that does not satisfy a predetermined criterion is included in the multiplexed light flowing through the path, and a restriction unit that controls that the light does not flow through the path when the non-compliant light is included in the multiplexed light.

One aspect of the present invention is a monitoring method including a step of receiving multiplexed light in which light output from a plurality of devices is multiplexed, a step of determining whether non-compliant light that does not satisfy a predetermined criterion is included in the received multiplexed light, and a step of controlling that the light does not flow through the path when the non-compliant light is included in the multiplexed light.

### Advantageous Effects of Invention

According to the above aspect, it is possible to block non-compliant light or stop output thereof in a network including a PG.

### BRIEF DESCRIPTION OF DRAWINGS

FIG. 1 is a schematic diagram of a desired wavelength and a residual wavelength when the desired wavelength is one wavelength in a monitoring system.

FIG. 2 is a schematic block diagram illustrating a configuration of a monitoring system according to Embodiment 1-1.

FIG. 3 is a schematic block diagram illustrating a first configuration example of a monitoring device according to Embodiment 1-1.

FIG. 4 is a diagram illustrating a first configuration example of a separation unit.

FIG. 5 is a diagram illustrating a second configuration example of the separation unit.

FIG. 6 is a diagram illustrating a third configuration example of the separation unit.

FIG. 7 is a diagram illustrating a fourth configuration example of the separation unit.

FIG. 8 is a flowchart illustrating monitoring processing by the monitoring device of the first configuration example according to Embodiment 1-1.

FIG. 9 is a diagram illustrating a second configuration example of the monitoring device according to Embodiment 1-1.

FIG. 10 is a flowchart illustrating monitoring processing by the monitoring device according to the second configuration example of Embodiment 1-1.

FIG. 11 is a diagram illustrating a third configuration example of the monitoring device according to Embodiment 1-1.

FIG. 12 is a flowchart illustrating monitoring processing by the monitoring device of the third configuration example according to Embodiment 1-1.

FIG. 13 is a schematic block diagram illustrating a configuration according to a first modification of the monitoring system according to Embodiment 1-1.

FIG. 14 is a schematic block diagram illustrating a configuration according to a second modification of the monitoring system according to Embodiment 1-1.

FIG. 15 is a schematic block diagram illustrating a configuration of a monitoring system according to Embodiment 1-2.

FIG. 16 is a diagram illustrating a first configuration example of a separation device according to Embodiment 1-2.

FIG. 17 is a diagram illustrating a second configuration example of the separation device according to Embodiment 1-2.

FIG. 18 is a schematic block diagram illustrating a first modification of the monitoring system according to Embodiment 1-2.

FIG. 19 is a schematic block diagram illustrating a configuration of a monitoring system according to Embodiment 1-3.

FIG. 20 is a schematic block diagram illustrating a first modification of the monitoring system according to Embodiment 1-3.

FIG. 21 is a schematic block diagram illustrating a configuration of a monitoring system according to Embodiment 1-4.

FIG. 22 is a diagram illustrating a first configuration example of a monitoring device according to Embodiment 2-1.

FIG. 23 is a flowchart illustrating monitoring processing by the monitoring device of the first configuration example according to Embodiment 2-1.

FIG. 24 is a diagram illustrating a second configuration example of the monitoring device according to Embodiment 2-1.

FIG. 25 is a diagram illustrating a third configuration example of the monitoring device according to Embodiment 2-1.

FIG. 26 is a flowchart illustrating monitoring processing by the monitoring device of the third configuration example according to Embodiment 2-1.

FIG. 27 is a diagram illustrating a configuration of a monitoring system according to a first configuration example of Embodiment 3.

FIG. 28 is a flowchart illustrating monitoring processing by the monitoring system according to Embodiment 3.

FIG. 29 is a schematic diagram illustrating a configuration of an optical cross connect system according to Embodiment 4.

FIG. 30 is a schematic block diagram illustrating a configuration of a control unit according to at least one embodiment.

### DESCRIPTION OF EMBODIMENTS

Hereinafter, an embodiment will be described in detail with reference to the drawings.

A monitoring system 11 described in the following embodiment monitors a path such as an optical fiber through which multiplexed light in which light output from a plurality of user devices is multiplexed flows. The plurality of user devices connected to the path performs communication using light having a wavelength set by a management device (not illustrated) that manages a network including the path. The monitoring system 11 detects a user device that outputs non-compliant light among the plurality of user devices connected to the path. The non-compliant light is light that does not satisfy a predetermined criterion. For example, light including a wavelength component other than a compliant wavelength at an unacceptable intensity or more or light having an intensity equal to or more than a lower limit value of a non-compliant intensity is non-compliant light. The unacceptable intensity at which the wavelength component other than the compliant wavelength is, for example, 1/100 (−20 dB) or 1/1000 (−30 dB) or more in comparison with the intensity of the compliant wavelength component, or may be −30 dBm or the like as an absolute value. The lower limit value of the non-compliant intensity may be, for example, an intensity that is harmful to the worker, an intensity that increases the probability of occurrence of an optical fuse phenomenon, an intensity that increases the risk of burning an open end, or an intensity that increases the risk of breakage of a device. For example, it may be +10 dBm or the like. In the following description, the side of a user device as an output source of an optical signal will be referred to as a “primary side”, and the side of a user device as an output destination of the optical signal will be referred to as a “secondary side”. In single-core bidirectional communication, the same transmission path is a primary side for the own device and a secondary side for a device facing the same transmission path.

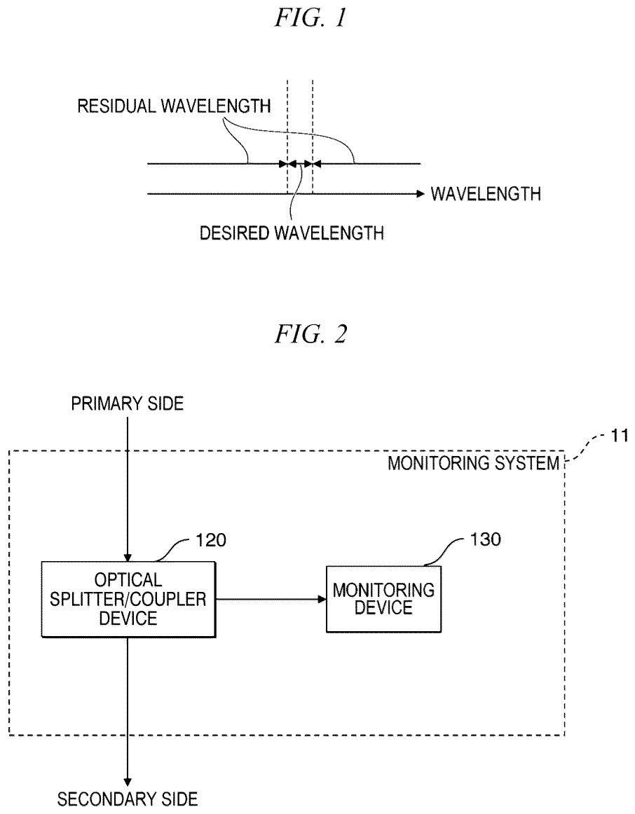

In the following description, a desired wavelength indicates a compliant wavelength range, and a residual wavelength indicates a wavelength range other than the desired wavelength. FIG. 1 is a schematic diagram of a desired wavelength and a residual wavelength when the desired wavelength is one wavelength in the monitoring system 11. The desired wavelength for one user device may be plural.

Note that the compliant wavelength range varies depending on a wavelength that may be used by the user device. For example, at the time of initial connection (in a state where the wavelength is not set in the user device), the wavelength range that may be used for the initial connection is the compliant wavelength range, and after the wavelength is set in the user device after the initial connection, the set wavelength range becomes the compliant wavelength range.

### Embodiment 1-1

The monitoring system 11 according to Embodiment 1-1 is provided in a path of a network or the like, and detects a user device that outputs light having a non-compliant wavelength among the plurality of user devices connected to the path.

### <<Configuration of Monitoring System 11>>

FIG. 2 is a schematic block diagram illustrating a configuration of the monitoring system 11 according to Embodiment 1-1. The monitoring system 11 according to Embodiment 1-1 includes an optical splitter/coupler device 120 and a monitoring device 130. The optical splitter/coupler device 120 is provided on a path to be monitored, and branches light input from a primary side into a secondary side and a monitoring device 130 side and outputs the light. The monitoring device 130 detects a user device that outputs light having a non-compliant wavelength on the basis of the light input from the optical splitter/coupler device 120.

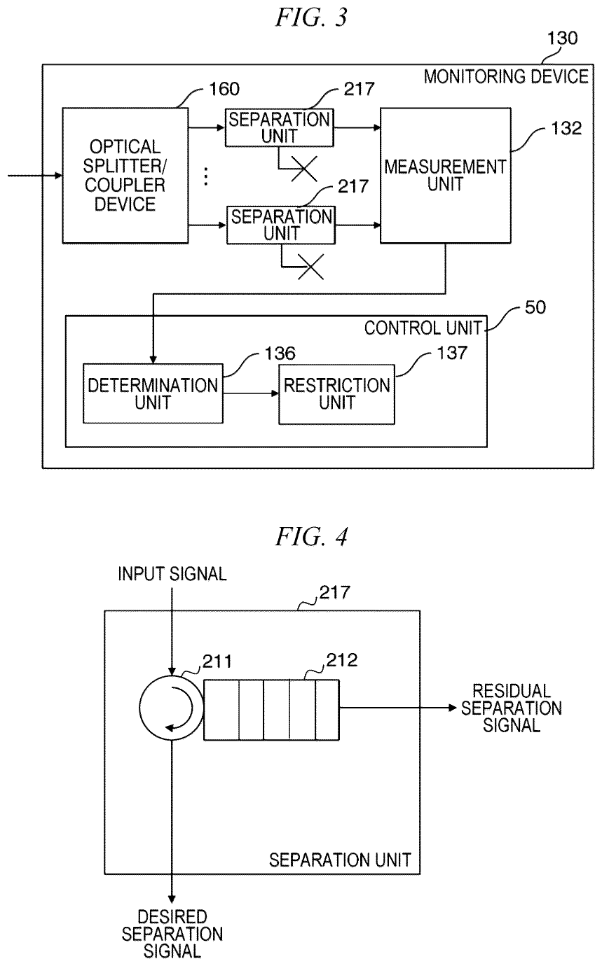

FIG. 3 is a schematic block diagram illustrating a first configuration example of the monitoring device 130 according to Embodiment 1-1.

The monitoring device 130 according to Embodiment 1-1 includes an optical splitter/coupler device 160, a plurality of separation units 217, a measurement unit 132, and a control unit 50. The optical splitter/coupler device 160 branches the light input from the optical splitter/coupler device 120 provided on the path, and outputs the light to each of the plurality of separation units 217.

### <<Separation Unit 217>>

The separation unit 217 processes the input optical signal (hereinafter referred to as a “separation input signal”). The separation unit 217 includes three ports including an input port, a first output port, and a second output port. The separation unit 217 wavelength-separates an optical signal (separation input signal) input from the input port into a signal having a desired wavelength (hereinafter referred to as a “desired separation signal”) that is set in the user device by a management device (not illustrated) that manages the network and a signal having a residual wavelength (hereinafter referred to as a “residual separation signal”) that is a wavelength component other than the desired wavelength. The desired separation signal is output from the first output port, and the residual separation signal is output from the second output port. However, in Embodiment 1-1, since the desired separation signal is not used in the monitoring device 130, the first output port of the separation unit 217 may be non-reflection-terminated. The separation unit 217 acquires wavelength setting data from the management device and sets a wavelength to be separated. The configuration of the separation unit 217 will be described later.

Depending on characteristics (suppression ratio and blocking capability) of a filter used in processing in the separation unit 217, when there is a component of the residual wavelength, the component of the residual wavelength is slightly mixed into the desired separation signal, and when there is a component of the desired wavelength, the component of the desired wavelength is slightly mixed into the residual separation signal. However, if the ratio of a desired signal to the separation input signal is significantly large, the desired signal occupies most of the desired separation signal and the residual separation signal, and if the ratio of the residual signal to the separation input signal is significantly large, the residual signal occupies most of the desired separation signal and the residual separation signal. Further, this can also occur depending on the suppression ratio of the filter.

### (First Configuration Example of Separation Unit 217)

FIG. 4 is a diagram illustrating a first configuration example of the separation unit 217. The separation unit 217 according to the first configuration example includes a fiber Bragg grating (FBG). The FBG is configured by creating a diffraction grating in an optical fiber. When light is incident on the FBG, only light of a specific wavelength component corresponding to the interval between the diffraction gratings is reflected, and light of other wavelength components passes. By using such characteristics and selecting an FBG that reflects light having a desired wavelength of the corresponding user device, the separation unit 217 using the FBG can be configured.

The separation unit 217 includes a circulator 211 and an FBG 212. The circulator 211 inputs an optical signal input from the primary side of the path to the FBG 212. The circulator 211 outputs the optical signal input from the FBG 212 to the secondary side of the path. The circulator 211 may be configured using, for example, an optical splitter/coupler device. When the circulator 211 is configured using a 2×2 optical splitter/coupler device, two ports on one side function as an input port and an output port, one of two ports on the opposite side is connected to the FBG 212, and the other port is configured with non-reflection termination. The circulator 211 may be configured using a 2×1 optical splitter/coupler device such that there is no open end. In this case, two ports on one side function as an input port and an output port, and one port on the opposite side is connected to the FBG 212. The FBG 212 reflects an optical signal having a desired wavelength and transmits an optical signal having a residual wavelength. By such reflection and transmission, the desired separation signal and the residual separation signal are separated from the separation input signal. Note that, in Embodiment 1-1, since the desired separation signal is not used in the monitoring device 130, the separation unit 217 does not include the circulator 211 and may be configured as a two-port device including an input port and an output port that outputs the residual separation signal. That is, the separation unit 217 according to Embodiment 1-1 may have a configuration including the FBG 212 between the input port and the output port.

### (Second Configuration Example of Separation Unit 217)

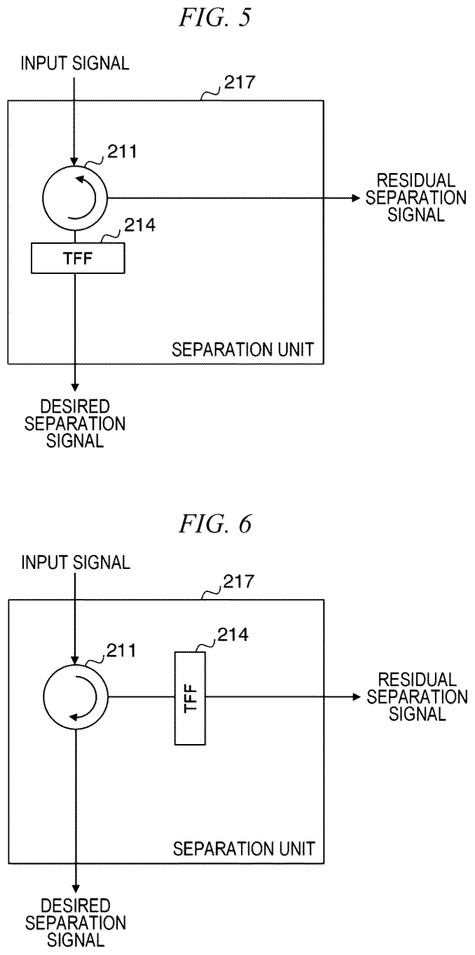

FIG. 5 is a diagram illustrating a second configuration example of the separation unit 217. The separation unit 217 according to the second configuration example includes a thin film filter (TFF). The TFF is a wavelength filter that reflects a part of light input so as to intersect with the film surface and transmits the rest. The TFF can vary the wavelength of light to be reflected or transmitted depending on the incident angle of light. The TFF is controlled to transmit the desired separation signal of the corresponding user device and reflect the residual separation signal.

The separation unit 217 includes a circulator 211 and a TFF 214. The circulator 211 inputs an optical signal input from the primary side of the path to the TFF 214. The circulator 211 inputs an optical signal input from the TFF 214 to the monitoring device 130. The configuration of the circulator 211 is as described above.

Note that, for example, in the circulator 211 in FIG. 3 and the circulator 211 in FIG. 4, the traveling direction of the light is reverse rotation as viewed from the paper surface. The traveling direction of the light of the circulator 211 is reversely rotated as described above in a case where the element in the separation unit 217 is configured to reflect the light having the compliant wavelength as in the FBG 212, for example, and in a case where the element is configured to transmit the light having the compliant wavelength as in the TFF 214, for example.

The TFF 214 transmits an optical signal having a desired wavelength and reflects an optical signal having a residual wavelength. The optical signal (residual separation signal) reflected by the TFF 214 is input to the monitoring device 130 via the circulator 211. By such reflection and transmission, the desired separation signal and the residual separation signal are separated from the separation input signal. Note that, also in FIG. 4 of a configuration for transmitting a desired wavelength, the circulator 211 may be configured using an optical splitter/coupler device as in FIG. 3 of a configuration for reflecting a desired wavelength. The same applies to other configurations.

### (Third Configuration Example of Separation Unit 217)

FIG. 6 is a diagram illustrating a third configuration example of the separation unit 217. The separation unit 217 includes the circulator 211 and the TFF 214. The circulator 211 inputs an optical signal input from the primary side of the path to the TFF 214. The circulator 211 outputs the optical signal input from the TFF 214 to the secondary side of the path. As in the first configuration example described with reference to FIG. 3, the circulator 211 may be configured using, for example, an optical splitter/coupler device. The TFF 214 reflects an optical signal having a desired wavelength of the corresponding user device and transmits an optical signal having a residual wavelength. By such reflection and transmission, the desired separation signal and the residual separation signal are separated from the separation input signal. Note that, in Embodiment 1-1, since the desired separation signal is not used in the monitoring device 130, the separation unit 217 does not include the circulator 211 and may be configured as a two-port device including an input port and an output port that outputs the residual separation signal. That is, the separation unit 217 according to Embodiment 1-1 may have a configuration including the TFF 214 between the input port and the output port.

### (Fourth Configuration Example of Separation Unit 217)

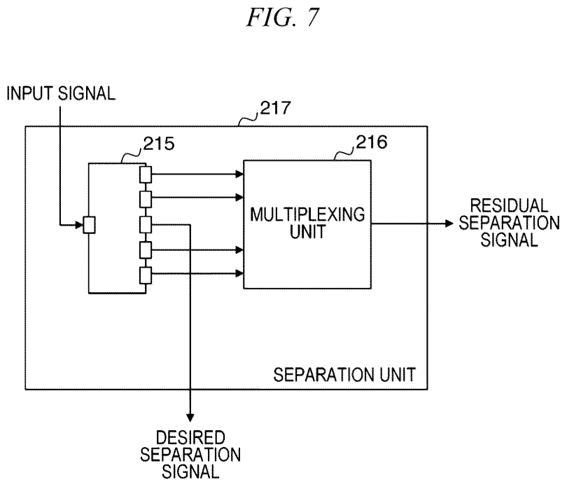

FIG. 7 is a diagram illustrating a fourth configuration example of the separation unit 217. The separation unit 217 includes an arrayed-waveguide grating (AWG) 215 and a multiplexing unit 216. The AWG 215 outputs an optical signal input from a primary side of the path from a port corresponding to a wavelength. Among the plurality of output ports of the AWG 215, the output port from which the desired separation signal of the corresponding user device is output is connected to the secondary side of the path. The remaining output ports are connected to the multiplexing unit 216. The multiplexing unit 216 multiplexes a plurality of residual separation signals input from the AWG 215 and outputs the resultant signal to the monitoring device 130. Any device may be applied to the multiplexing unit 216 as long as the device can multiplex optical signals of a plurality of wavelengths. For example, the multiplexing unit 216 may be configured using an AWG. In this case, a plurality of output ports that output the residual separation signal of the AWG 215 is connected to input ports of the multiplexing unit 216 (AWG) according to the wavelength of each residual signal. The multiplexing unit 216 may be configured using an optical splitter/coupler device. An isolator may be provided between a separation device 170 and a monitoring device 130. Note that, in order to prevent an output non-compliant wavelength component from being blocked by the multiplexer/demultiplexer and not detected, the multiplexing unit 216 desirably has a wavelength transmission characteristic equivalent to that of the AWG 215 or has less blocking, for example, has a large crosstalk between adjacent channels, that is, between adjacent ports.

### (Another Configuration Example of Separation Unit 217)

In addition, the separation unit 217 may be configured using a waveguide type ring resonator, a lattice type optical filter, a Mach-Zehnder interferometer, or the like.

As the waveguide type ring resonator, for example, a micro ring resonator (MRR) having a resonator length of several 10 μm and a resonance wavelength interval (free spectral range (FSR)) of several 10 nm may be used. As the shape of the ring resonator part, a racetrack shape in which the coupling portion is a parallel straight waveguide instead of a perfect circular shape may be used. With such a configuration, the coupling coefficient at the coupling portion can be easily designed. Specifically, the waveguide type ring resonator receives an optical signal from the primary side of the path to an incident port, outputs the desired separation signal from a drop port to the secondary side of the path, and outputs the residual separation signal from a through port to the monitoring device 130. A non-reflection-termination or isolator is desirably connected to an add port.

The lattice type optical filter includes, for example, a delay line, a symmetric Mach-Zehnder interferometer type coupling rate variable coupler, and a phase adjustment unit. By changing a phase shift value of the optical filter, an arbitrary filter characteristic whose upper limit is performance determined by an asymmetric Mach-Zehnder interferometer can be obtained. A property that a characteristic periodically appears for each free spectral range (FSR) determined by ΔL is used. In the lattice type optical filter, a path length difference of each asymmetric MZI constituting the lattice is ΔL. When signal light is input to the port on the primary side, a delay ΔL, a coupling rate of the coupling rate variable coupler, and a phase G of a phase shifter are adjusted so that the first port on the secondary side outputs a compliant wavelength component and the second port on the secondary side outputs a non-compliant wavelength component.

When the Mach-Zehnder interferometer is used, a set of FBGs is provided on each arm of the Mach-Zehnder interferometer. When the distances from directional couplers on the input side constituting the Mach-Zehnder interferometer to two gratings are the same, the reflected light merges and interferes, and is then output from a lower left port. Therefore, it is necessary not only to match the characteristics of the two gratings, but also to match the distances from the directional couplers to the gratings with accuracy of at least a wavelength or less, for example, accuracy of 1/10 or less of the wavelength. Accordingly, a method of adjusting the optical length by what is called trimming such as changing the refractive index by applying ultraviolet light to the portion between the gratings and the directional couplers after the gratings are formed is also necessary.

### <<Measurement Unit 132>>

The measurement unit 132 measures the intensity of the light output from the separation unit 217. For example, the measurement unit 132 may be implemented by a combination of a photoelectric conversion element such as a photodiode (PD) and an avalanche photodiode (APD) and a circuit that measures a voltage, or the like.

### <<Control Unit 50>>

The control unit 50 performs control for detecting a user device that outputs light having a non-compliant wavelength. As illustrated in FIG. 3, the control unit 50 functions as a determination unit 136 and a restriction unit 137.

The determination unit 136 determines whether the intensity of multiplexed light measured by the measurement unit 132 exceeds a non-signal threshold. As the non-signal threshold, an allowable intensity for a component other than the wavelength assumed as compliant, for example, an intensity to an extent that it is considered that there is no signal reception is set.

The restriction unit 137 outputs an instruction related to the output of the signal light to the user device. Specifically, when causing the user device to restrict the output of the signal light, the restriction unit 137 outputs a restriction instruction to the user device. The output restriction is, for example, stop of output or reduction in output intensity. When the user device is caused to release the output restriction of the signal light, a restriction release instruction is output to the user device. The restriction release is, for example, start or restart of output or an increase in output intensity. The instruction of the restriction unit 137 may be transmitted by communication using a predetermined carrier, may be transmitted by multiplexing the main signal by frequency division multiplexing such as an auxiliary management and control channel (AMCC), time division multiplexing, or the like, or may be transmitted via a specific communication path. Further, the restriction unit 137 may issue a notification related to the output restriction to the management device, and the management device that has received the notification may output an instruction to the user device.

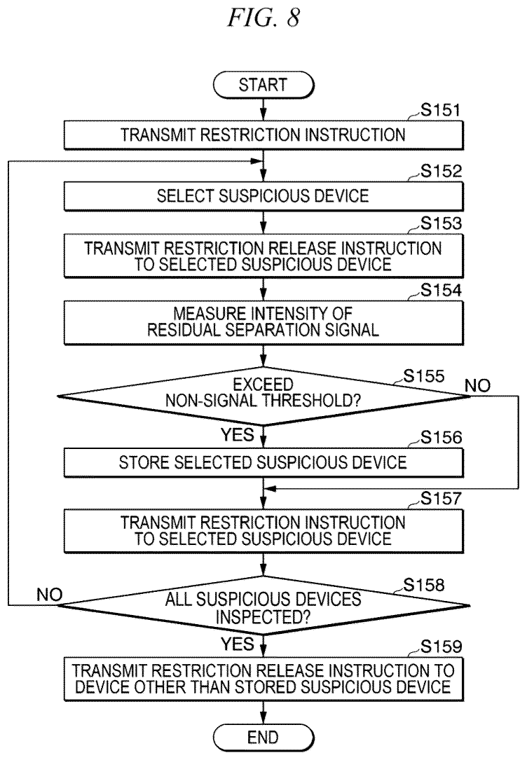

FIG. 8 is a flowchart illustrating monitoring processing by the monitoring device 130 of the first configuration example according to Embodiment 1-1.

The monitoring device 130 according to Embodiment 1-1 executes first monitoring processing illustrated in FIG. 8 every predetermined monitoring cycle. The restriction unit 137 transmits a signal light restriction instruction to all the user devices connected to the path monitored by the monitoring device 130 (step S151).

Next, the monitoring device 130 inspects wavelength abnormality according to the following procedure from step S152 to step S158 with each user device as a suspicious device. The “wavelength abnormality” refers to an abnormality related to the output of light having a non-compliant wavelength. The suspicious device is a user device in which a suspicion of the wavelength abnormality is not eliminated. First, the restriction unit 137 selects one of suspicious devices (step S152) and transmits a restriction release instruction of the signal light to the suspicious device (step S153). The measurement unit 132 measures the intensity of the residual separation signal input from the separation unit 217 corresponding to the selected user device (step S154). The residual separation signal received at this time is a residual separation signal separated from light output from the user device selected in step S152.

The determination unit 136 determines whether or not the intensity of the residual separation signal measured in step S154 exceeds the non-signal threshold (step S155). When the intensity of the residual separation signal does not exceed the non-signal threshold (step S155: NO), the determination unit 136 determines that the user device selected in step S152 is normal. On the other hand, when the intensity of the residual separation signal exceeds the non-signal threshold (step S155: YES), the determination unit 136 determines that the user device selected in step S152 has wavelength abnormality. The restriction unit 137 stores the ID of the user device selected in step S152 in an internal memory (step S156). When it is determined whether or not the user device selected in step S152 is normal, the restriction unit 137 transmits a restriction instruction to the user device (step S157).

The monitoring device 130 determines whether or not there are any uninspected suspicious devices (step S158). When any uninspected suspicious devices remain (step S158: NO), the monitoring device 130 returns the processing to step S152 and inspects the remaining suspicious device. On the other hand, when there is no more uninspected suspicious device, a restriction release instruction is transmitted to a user device other than the user device stored in step S156 (step S159), and the processing is terminated.

Note that the processing of the monitoring device 130 is not limited to the first monitoring processing illustrated in FIG. 8. For example, in another embodiment, monitoring may be performed by the following procedure instead of the first monitoring processing. The monitoring device 130 does not issue the restriction instruction in step S151 of FIG. 8, and transmits the restriction instruction only to the suspicious device selected in step S153 instead of the restriction release instruction. When a change in the measured value of the intensity before and after the transmission of the restriction instruction exceeds the non-signal threshold in step S155 of FIG. 8, the monitoring device 130 maintains the restriction state. The monitoring device 130 transmits the restriction release instruction when the change in the measured value of the intensity before and after transmission of the restriction instruction does not exceed the non-signal threshold in step S155 of FIG. 8.

That is, if the amount of change before and after the restriction is equal to or greater than the non-signal threshold, that is, if the residual separation signal decreases by equal to or more than the non-signal threshold, the output of the residual component is non-zero, and thus it is possible to estimate that the target user device is suspicious. On the other hand, if the amount of change before and after the restriction is less than the non-signal threshold, that is, if the residual separation signal does not decrease by equal to or more than the non-signal threshold, it is possible to estimate that the output of the residual component is non-zero, and thus it is possible to estimate that the target user device is not suspicious. In this case, the transmission of the restriction instruction in step S157 and the transmission of the restriction release instruction in step S159 are not performed. In addition, it is not always necessary to record the suspicious device in step S156.

Further, in another embodiment, the restriction instruction may not be issued in step S151, the restriction instruction may be transmitted only to the suspicious device selected instead of the restriction release instruction in step S153, whether or not the suspicious device is non-compliant may be recorded on the basis of the change in the measured value of the intensity before and after the transmission of the restriction instruction in step S155, the restriction release instruction may be transmitted instead of the restriction instruction in step S157 regardless of whether or not the suspicion is eliminated, and when it is determined in step S158 that there is no more uninspected suspicious device, the restriction instruction may be output instead of the restriction release instruction in step S159 to the device recorded as non-compliant in step S156, and the processing may be terminated.

Note that the monitoring device 130 detects a user device that outputs light having a non-compliant wavelength on the basis of the intensity of the residual separation signal, but is not limited thereto. For example, in other embodiments, the monitoring device 130 may detect the user device that outputs light having a non-compliant wavelength on the basis of the intensity of the desired separation signal. That is, in the monitoring device 130, the first output port of the separation unit 217 may be connected to the measurement unit 132, and the second output port may be terminated. In this case, in step S154, the determination unit 136 measures the intensity of the desired separation signal output from the separation unit 217 other than the separation unit 217 related to the suspicious device.

Since the user device other than the suspicious device does not output light, when the desired separation signal corresponding to at least one user device other than the suspicious device exceeds (is non-zero) the non-signal threshold, it can be seen that the suspicious device outputs light having a non-compliant wavelength. Also in this case, the monitoring device 130 can specify which user device's desired wavelength the non-compliant light is leaking into.

Further, the monitoring device 130 according to another embodiment may cause one user device to restrict the output of light, release the restriction of the other user devices, and detect the user device that outputs light having a non-compliant wavelength on the basis of the intensity of the desired separation signal. In this case, the determination unit 136 measures the intensity of the desired separation signal output from the separation unit 217 related to one user device in which the output of light is restricted in step S154.

Since only the one user device with restricted output does not output light, when the intensity of the desired separation signal of the user device is non-zero (exceeds the non-signal threshold), it can be seen that any of the other user devices outputs light having a non-compliant wavelength. Note that, in this case, it is unknown whether or not the user device whose output is stopped is outputting light having a non-compliant wavelength. Accordingly, for example, the monitoring device 130 stops the plurality of user devices, searches for a combination in which the intensities of the desired separation signals of the plurality of user devices become zero (equal to or less than the non-signal threshold), and determines that the user device whose output is not restricted at that time is not suspicious.

### (Second Configuration Example of Monitoring Device 130)

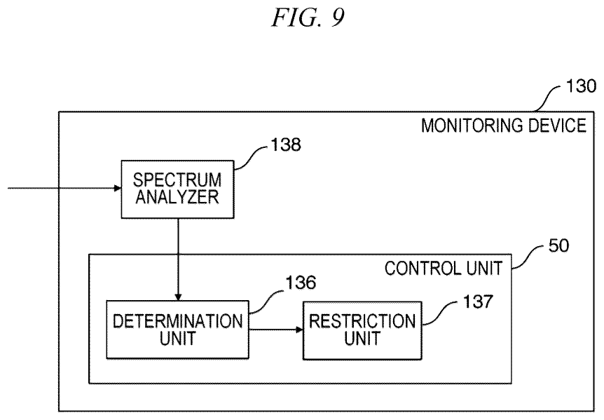

FIG. 9 is a diagram illustrating a second configuration example of the monitoring device 130 according to Embodiment 1-1. The monitoring device 130 according to the second configuration example includes a spectrum analyzer 138 instead of the optical splitter/coupler device 160, the separation unit 217, and the measurement unit 132 of the first configuration example. Other configurations of the monitoring device 130 according to the second configuration example are similar to those of the first configuration example. The spectrum analyzer 138 measures the distribution of wavelength components included in the received signal, that is, the relationship between the wavelength and the intensity.

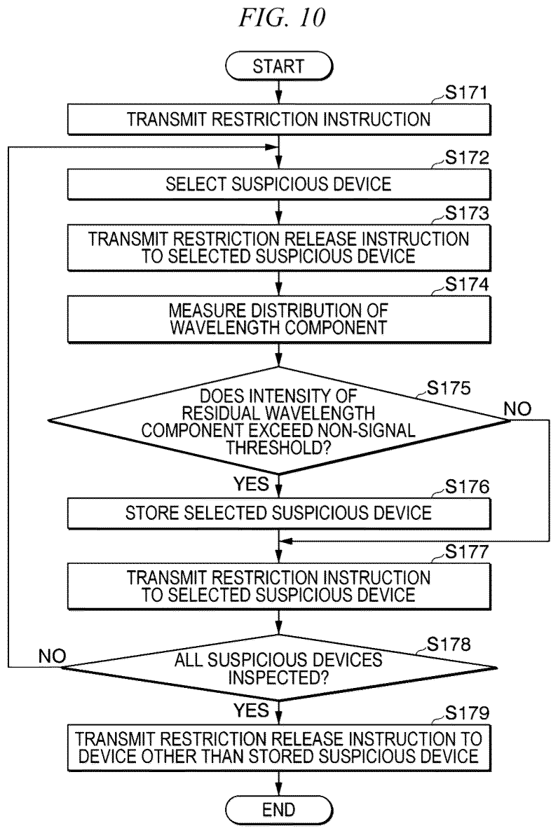

FIG. 10 is a flowchart illustrating monitoring processing by the monitoring device 130 according to the second configuration example of Embodiment 1-1.

The monitoring device 130 according to the second configuration example of Embodiment 1-1 executes the monitoring processing illustrated in FIG. 10 every predetermined monitoring cycle. The restriction unit 137 transmits a signal light restriction instruction to all the user devices connected to the path monitored by the monitoring device 130 (step S171).

Next, the monitoring device 130 inspects the wavelength abnormality according to the following procedure from step S172 to step S178 with each user device as a suspicious device. First, the restriction unit 137 selects one of the suspicious devices (step S172) and transmits a restriction release instruction of the signal light to the suspicious device (step S173). The spectrum analyzer 138 measures the distribution of wavelength components of the light input from the optical splitter/coupler device 120 (step S174).

The determination unit 136 determines whether or not the intensity of the component related to the residual wavelength of the user device selected in step S172 among the wavelength components measured in step S174 exceeds the non-signal threshold (step S175). When the intensity of the residual wavelength component does not exceed the non-signal threshold (step S175: NO), the determination unit 136 determines that the user device selected in step S172 is normal. On the other hand, when the intensity of the residual wavelength component exceeds the non-signal threshold (step S175: YES), the determination unit 136 determines that the user device selected in step S172 has wavelength abnormality. Note that, at this time, by confirming whether or not the wavelength of the component exceeding the non-signal threshold is a desired wavelength of another user device, the determination unit 136 can specify whether or not the non-compliant light is leaking as desired wavelength by the other user device.

The restriction unit 137 stores the ID of the user device selected in step S172 in a storage device (memory or the like) (not illustrated) (step S176). When it is determined whether or not the user device selected in step S172 is normal, the restriction unit 137 transmits a restriction instruction to the user device (step S177).

The monitoring device 130 determines whether or not there are any uninspected suspicious devices (step S178). When any uninspected suspicious devices remain (step S178: NO), the monitoring device 130 returns the processing to step S172 and inspects the remaining suspicious device. On the other hand, when there is no more uninspected suspicious device, a restriction release instruction is transmitted to a user device other than the user device stored in step S176 (step S179), and the processing is terminated.

Note that the processing of the monitoring device 130 is not limited to the first monitoring processing illustrated in FIG. 10. For example, in another embodiment, the restriction instruction may not be issued in step S171, the restriction instruction may be transmitted only to the suspicious device selected instead of the restriction release instruction in step S173, the restriction state may be maintained when the change in the measured value of the intensity of the residual wavelength component before and after the transmission of the restriction instruction exceeds the non-signal threshold in step S175, and the restriction release instruction may be transmitted when the change does not exceed the non-signal threshold. In this case, recording of the suspicious device in step S156, the transmission of the restriction instruction in step S157, and the transmission of the restriction release instruction in step S159 are not performed.

Further, in another embodiment, the restriction instruction may not be issued in step S171, the restriction instruction may be transmitted only to the suspicious device selected instead of the restriction release instruction in step S173, whether or not the suspicious device is non-compliant may be recorded on the basis of the change in the measured value of the intensity before and after the transmission of the restriction instruction in step S175, the restriction release instruction may be transmitted instead of the restriction instruction in step S177 regardless of whether or not the suspicion is eliminated, and when it is determined in step S178 that there is no more uninspected suspicious device, the restriction instruction may be output instead of the restriction release instruction in step S159 to the device recorded as non-compliant in step S176, and the processing may be terminated.

Further, in another embodiment, instead of the spectrum analyzer 138, a multiplexer/demultiplexer that outputs a plurality of wavelengths to respective different outputs, for example, one AWG 215 including at least one input port and a plurality of output ports, and a measurement unit 132 that measures the intensity of light input from each of the plurality of ports may be included. In this case, the measurement unit 132 can measure the intensity of light input from the port corresponding to the desired wavelength of each user device as the intensity of the desired wavelength, and can measure the total sum of the intensities of light input from the other ports as the intensity of the residual wavelength. With this configuration, it is not necessary to perform a wavelength sweep unlike the spectrum analyzer 138, and thus the measurement processing time can be shortened.

### (Third Configuration Example of Monitoring Device 130)

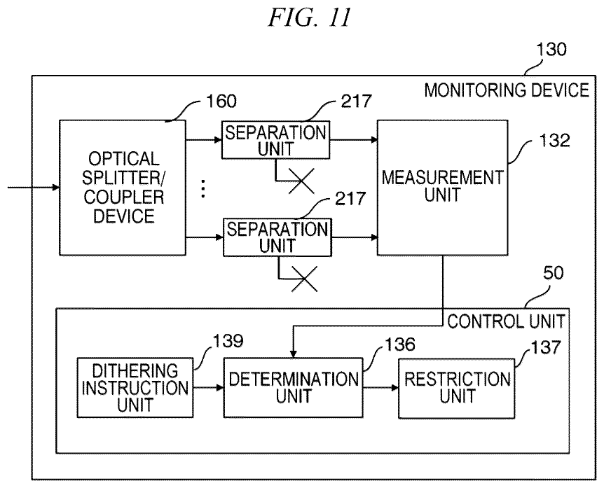

FIG. 11 is a diagram illustrating a third configuration example of the monitoring device 130 according to Embodiment 1-1. The monitoring device 130 according to the third configuration example includes a dithering instruction unit 139 in addition to the configuration of the first configuration example. Other configurations of the monitoring device 130 according to the third configuration example are similar to those of the first configuration example. The dithering instruction unit 139 outputs a dithering instruction and a dithering release instruction to the user device. The dithering instruction is an instruction to modulate (or superimpose) the optical signal with a frequency or a time-series pattern different for each user device. Hereinafter, a frequency or a time-series pattern for modulating the optical signal by the dithering instruction is referred to as a dithering component.

With the dithering component, it is possible to uniquely identify the user device that is the transmission source of the optical signal modulated with the dithering component. On the other hand, the dithering release instruction is an instruction to cause the user device to stop the modulation of the optical signal with the dithering component.

Further, the measurement unit 132 according to the third configuration example has a function of extracting the intensity of the dithering component of each user device from the reception intensity of the optical signal. When the dithering component is a frequency, the measurement unit 132 extracts the intensity of a frequency component, and when the dithering component is a pattern, the measurement unit 132 extracts the intensity of a component corresponding to the pattern. The measurement unit 132 includes, for example, a lock-in amplifier.

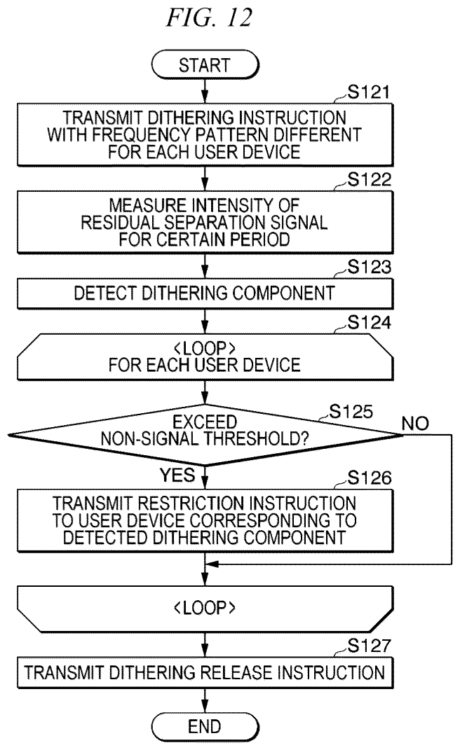

FIG. 12 is a flowchart illustrating monitoring processing by the monitoring device 130 of the third configuration example according to Embodiment 1-1. The monitoring device 130 executes the monitoring processing illustrated in FIG. 12 every predetermined monitoring cycle.

The dithering instruction unit 139 determines respective different patterns for all the user devices connected to the path monitored by the monitoring device 130, and transmits a dithering instruction with the determined pattern to each user device (step S121). Examples of the modulation pattern include a modulation pattern in which the intensity of the optical signal is changed at different frequencies for each user device. At this time, the dithering instruction unit 139 determines the frequencies of the user devices to be frequencies that are not multiples or divisors of each other. As another example of the modulation pattern, the intensity or the wavelength of the optical signal is changed at different timings for each user device. At this time, the dithering instruction unit 139 determines timings at which the intensity of each user device is changed to timings that do not overlap each other.

The measurement unit 132 measures the intensity of each of the residual separation signals input from each separation unit 217 for a certain period (step S122). The measurement unit 132 detects a dithering component of the frequency set for the user device in a residual separation wavelength of the corresponding user device from the time series of the intensity of each residual separation signal in the certain period (step S123).

Next, the monitoring device 130 selects the user devices one by one (step S124) and executes the following processing. The determination unit 136 determines whether or not the dithering component set in the user device has been detected to exceed the non-signal threshold in the residual separation wavelength of the selected user device (step S125). When the dithering component set in the corresponding user device is not detected or when the dithering component is detected to be equal to or less than the non-signal threshold (step S125: NO), the determination unit 136 determines that the corresponding user device is normal. On the other hand, when the dithering component set in the corresponding user device is detected to exceed the non-signal threshold (step S125: YES), the determination unit 136 determines that the corresponding user device has wavelength abnormality. In this case, the restriction unit 137 transmits a signal light restriction instruction to the corresponding user device (step S126). Thus, it is possible to stop the output of the optical signal by the user device that outputs the light having a non-compliant wavelength.

When the monitoring device 130 performs the above-described determination processing on each user device, the dithering instruction unit 139 transmits a dithering release signal to the user device determined to be normal (step S127).

Note that the monitoring device 130 detects a user device that outputs light having a non-compliant wavelength on the basis of the intensity of the residual separation signal, but is not limited thereto. For example, in other embodiments, the monitoring device 130 may detect the user device that outputs light having a non-compliant wavelength on the basis of the intensity of the desired separation signal. That is, in the monitoring device 130, the first output port of the separation unit 217 may be connected to the measurement unit 132, and the second output port may be terminated. In this case, in step S122, the determination unit 136 measures the intensity of the desired separation signal output from the separation unit 217 other than the separation unit 217 related to the suspicious device. In the desired separation signal output from the at least one separation unit 217, when the intensity of the dithering component related to the suspicious device exceeds the non-signal threshold, it can be seen that the suspicious device outputs light having a non-compliant wavelength. Also in this case, the monitoring device 130 can specify which user device's desire wavelength the non-compliant light is leaking into.

Further, in another embodiment, the control unit 50 of the monitoring device 130 including the spectrum analyzer 138 as illustrated in FIG. 9 may include a dithering instruction unit 139 as illustrated in FIG. 11. In this case, in step S125 illustrated in FIG. 12, the spectrum analyzer 138 determines whether or not the intensity of the residual wavelength component of each user device exceeds the non-signal threshold, whereby similar processing can be performed.

Further, in another embodiment, instead of the optical splitter/coupler device 160 and the plurality of separation units 217, a multiplexer/demultiplexer that outputs a plurality of wavelengths to respective different outputs, for example, one AWG 215 including at least one input port and a plurality of output ports may be provided. In this case, the measurement unit 132 can measure the intensity of light input from the port corresponding to the desired wavelength of each user device as the intensity of the desired wavelength component, and can measure the total sum of the intensities of light input from the other ports as the intensity of the residual wavelength component. Then, the control unit 50 can perform similar processing by determining whether or not the intensity of the residual wavelength component of each user device exceeds the non-signal threshold in step S125 illustrated in FIG. 12.

Even in the configuration including one multiplexer/demultiplexer instead of the optical splitter/coupler device 160 and the plurality of separation units 217, as described above, it is possible to detect the user device that outputs the light having a non-compliant wavelength on the basis of the intensity of the desired separation signal. In this case, the control unit 50 can perform similar processing by measuring the intensity of light input from the port corresponding to the desired wavelength of each user device as the intensity of the desired wavelength component, and determining whether or not the dithering component of the suspicious device is included.

### <<Operations and Effects>>

As described above, when the intensity of the residual separation signal separated from the separation unit 217 exceeds the non-signal threshold, the monitoring device 130 according to Embodiment 1-1 performs control so that the optical signal does not flow by transmitting a stop signal to the user device. A wavelength included in the residual separation signal is a wavelength that is not set in the user device by the host device. That is, the fact that the intensity of the residual separation signal exceeds the non-signal threshold indicates that the multiplexed light includes light having a non-compliant wavelength. Note that, in an initial state until a desired wavelength is set by the host device, the separation unit 217 may pass light of all wavelengths to the secondary side and does not need to separate the light. Note that, when a user device in the initial state and a user device in which the desired wavelength is set are mixed due to addition of a user device or the like, the separation unit 217 may also initialize a user device stopped due to a previous non-compliant and verify again. While there is the user device in the initial state, even if non-compliant light corresponding to the initial state exists, it is estimated that the non-compliant light is caused by the user device in the initial state, and the monitoring device 130 may not identify the non-compliant UT, and may identify the non-compliant UT after the desired wavelength is set.

In addition, until the desired wavelength is set, the monitoring device 130 may set the wavelength that can be used in the initial state as the desired wavelength, change the desired wavelength to the set wavelength after setting the desired wavelength, and execute the above-described monitoring processing.

In this manner, the monitoring device 130 can perform control so that the non-compliant light is not conducted in the PG.

In addition, when non-compliant light is included in the multiplexed light, the monitoring device 130 according to the first and second configuration examples performs control so that optical signals from some user devices of the plurality of user devices do not flow and optical signals from other user devices do not flow. Then, the monitoring device 130 determines whether or not the intensity of the optical signal from some user devices exceeds a non-signal threshold.

Specifically, the monitoring device 130 causes the connected user device to sequentially output the optical signal after stopping the output of the optical signal. Thus, the monitoring device 130 can specify the user device having the wavelength abnormality and perform control so that the optical signal from the user device does not flow.

Note that the monitoring device 130 according to the first and second configuration examples specifies the user device having the wavelength abnormality by switching the user devices that output the optical signals one by one, but the present invention is not limited thereto. For example, in another embodiment, the monitoring device 130 may specify the user device having the wavelength abnormality by switching the user devices that do not output the optical signal one by one. In this case, when the difference between the light intensity at the timing before restricting the optical signal of a certain user device and the light intensity at the timing after restricting exceeds the non-signal threshold, the determination unit 136 determines that the user device outputs the non-compliant light. Furthermore, for example, in another embodiment, the monitoring device 130 may specify the user device with the wavelength abnormality by, for example, binary search. In this case, the monitoring device 130 causes half of the connected user devices to stop the optical signal, and when the intensity of the multiplexed light received immediately after stopping the optical signal does not become equal to or less than the non-signal threshold, further causes half of the user devices not falling within the allowable range to stop the optical signal, and sequentially proceeds until the wavelength abnormality is specified. On the other hand, when the intensity of the multiplexed light received immediately after stopping the optical signal becomes equal to or less than the non-signal threshold, the monitoring device 130 causes more half of the user devices that have stopped the signal to output the optical signal. When the intensity of the multiplexed light received immediately after the optical signal is stopped becomes equal to or less than the non-signal threshold, the suspicion of the wavelength abnormality is eliminated for the user device that outputs the optical signal.

The monitoring device 130 can specify the user device that outputs the non-compliant light by repeatedly performing the above procedure.

In addition, the monitoring device 130 according to the third configuration example can specify the user device that outputs the non-compliant light by observing the dithering component while maintaining the output of the optical signal to the user device.

Note that, with the monitoring device 130 according to each configuration example of Embodiment 1-1 described above, each user device operates according to the restriction instruction and the restriction release instruction from the monitoring device 130, so that it is possible to detect the non-compliant of each user device and perform control such that the non-compliant light is not conducted. On the other hand, also when some user devices do not follow the restriction instruction and the restriction release instruction, the monitoring device 130 can determine the presence or absence of non-compliant of other user devices. For example, when there is only one user device having wavelength abnormality and only the user device having the wavelength abnormality does not follow, when a restriction signal is transmitted to each user device in step S153 or step S173, the user device other than the user device having the wavelength abnormality stops the output according to the restriction signal, and only the user device having the wavelength abnormality does not stop the output. Thus, the monitoring device 130 can determine the output of the user device of normal output by measuring the intensity of the light after transmitting the restriction instruction in step S153 or step S173, and resetting the non-signal threshold on the basis of the difference from the intensity. Note that, when the user device of normal output does not follow the instruction, even if there is a plurality of user devices that do not follow the instruction, the user devices can be identified. In this case, the monitoring device 130 may determine whether or not the user device follows the instruction by an acknowledgement response to the user device or the like.

Note that the monitoring device 130 may include a multiplexer/demultiplexer that outputs a plurality of wavelengths to respective different outputs, for example, one AWG 215, instead of the optical splitter/coupler device 160 and the plurality of separation units 217 illustrated in FIGS. 3 and 11. The AWG 215 includes at least one input port and a plurality of output ports. All of the plurality of output ports of the AWG 215 are connected to the monitoring device 130, and each intensity is individually measured. The AWG 215 outputs an optical signal input from the primary side of the path from a port corresponding to a wavelength. Therefore, light having a desired wavelength of each user device is output from different output ports. Thus, when determining the presence or absence of non-compliant for a certain user device, the monitoring device 130 can specify a port to which a desired wavelength of the user device is input, and determine the presence or absence of non-compliant on the basis of light input to the port or on the basis of light input to a port other than the port.

### <<First Modification>>

FIG. 13 is a schematic block diagram illustrating a configuration according to a first modification of the monitoring system 11 according to Embodiment 1-1. The monitoring system 11 according to the first modification includes a blocking unit 150 in the subsequent stage of the optical splitter/coupler device 120 in addition to the configuration of Embodiment 1-1. The blocking unit 150 switches between passing and blocking of an input optical signal in accordance with an instruction from the monitoring device 130. The blocking unit 150 may include, for example, an optical switch (SW), an optical attenuator with a desired suppression ratio, a semiconductor optical amplifier (SOA) with a desired suppression ratio for switching between transmission and block by controlling a gain, a modulator with a desired suppression ratio, and the like by fiber cross connect (FXC) controlled to connect or not connect paths. When the blocking unit 150 is implemented by the modulator, the following configuration can be employed as a specific example. For example, the modulator may be a device that changes a light absorption rate by an electro refractive ER effect to change a refractive index by controlling a carrier (conduction electron and hole) concentration or applying an electric field. Furthermore, the blocking unit 150 may be a device using an electro-absorption (EA) effect. Note that, among ER types, those having a wide blocking wavelength (for example, Mach-Zehnder type) are particularly suitable. Note that the blocking unit 150 includes a compliant and non-compliant target wavelength as a wavelength that can be blocked regardless of the configuration in which the blocking unit 150 is implemented. The target wavelength includes at least a wavelength that may be allocated by the management device to the user device. In addition, the target wavelength is not likely to be assigned, but preferably includes a wavelength that interferes with a communication device due to a non-linear optical effect such as the Raman effect and four-wave mixing, and a wavelength that can affect the gain of an optical amplifier (not illustrated) on the path and gain characteristics with respect to the wavelength. Note that the configuration of the separation unit 217 and the configuration of the monitoring device 130 may be those illustrated in each configuration example of Embodiment 1-1.

The monitoring device 130 according to the first modification performs the following processing in addition to the monitoring processing of Embodiment 1-1. The restriction unit 137 of the monitoring device 130 outputs a blocking instruction to the blocking unit 150 when the intensity of at least one residual separation signal exceeds the non-signal threshold. Thus, the blocking unit 150 blocks the light input from the primary side. Accordingly, the monitoring device 130 can prevent the non-compliant light from being conducted to the secondary side of the path by outputting the blocking instruction to the blocking unit 150 when one or more residual separation signals whose intensity exceeds the non-signal threshold exist.

Further, the restriction unit 137 of the monitoring device 130 outputs an opening instruction to the blocking unit 150 after the intensity of the residual separation signal related to the user device as a blocking target does not exceed the non-signal threshold. Note that the monitoring system 11 illustrated in FIG. 13 blocks the light output from all the user devices when any one of the plurality of user devices is the object to be blocked. Thus, the blocking unit 150 conducts light input from the primary side of the path to the secondary side.

As described above, since the monitoring device 130 according to the first modification of Embodiment 1-1 includes the blocking unit 150, it is possible to prevent the non-compliant light from being conducted to the secondary side even when the user device does not follow the instruction of the monitoring device 130 and outputs an optical signal. Note that, when the user device 20 that outputs light having a non-compliant wavelength does not follow the restriction instruction, not only the signal light of the user device 20 but also the signal light of other user devices 20 remains blocked.

### <<Second Modification>>

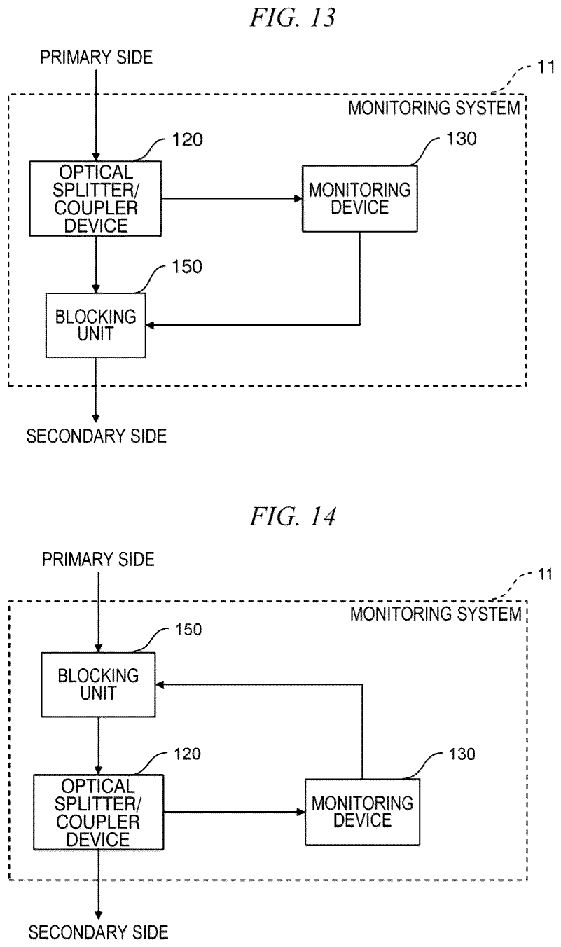

FIG. 14 is a schematic block diagram illustrating a configuration according to a second modification of the monitoring system 11 according to Embodiment 1-1. According to the second modification, the blocking unit 150 of the monitoring system 11 may be provided in the preceding stage of the optical splitter/coupler device 120. The monitoring device 130 executes monitoring processing similar to that of Embodiment 1-1, for example, and then outputs a blocking instruction to the blocking unit 150 when the intensity of the residual separation signal remains above the non-signal threshold because the user device does not follow the restriction instruction.

### Embodiment 1-2

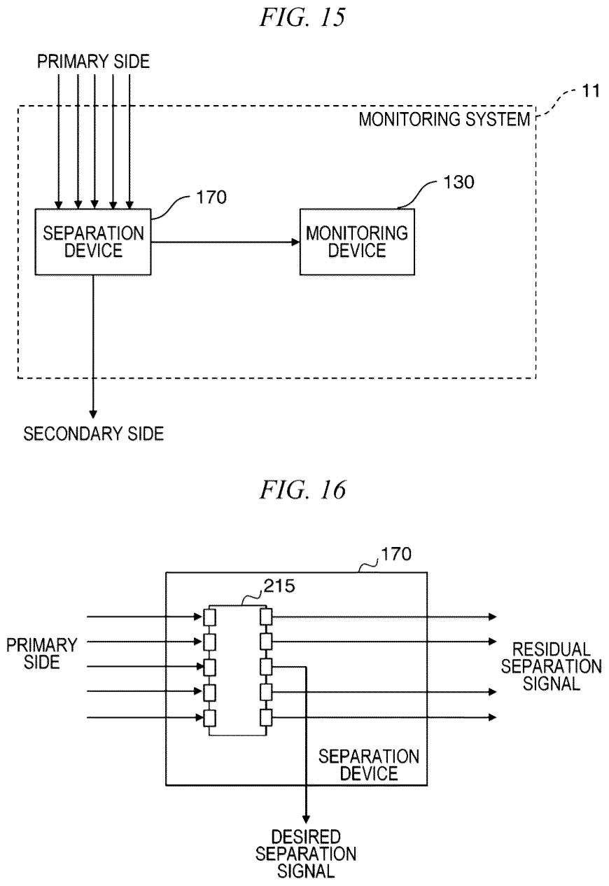

FIG. 15 is a schematic block diagram illustrating a configuration of the monitoring system 11 according to Embodiment 1-2. While the monitoring system 11 according to Embodiment 1-1 receives multiplexed light from one port on the primary side, the monitoring system 11 according to Embodiment 1-2 includes the plurality of ports on the primary side, and receives signal light from each of the plurality of user devices. As illustrated in FIG. 15, the monitoring system 11 according to Embodiment 1-2 includes a separation device 170 and a monitoring device 130. The separation device 170 includes a plurality of input ports to which signal light is input from the user device, a first output port that outputs the desired separation signal, and a second output port that outputs the residual separation signal.

### <<First Configuration Example of Separation Device 170>>

FIG. 16 is a diagram illustrating a first configuration example of the separation device 170 according to Embodiment 1-2. The separation device 170 according to the first configuration example includes an AWG 215 having a plurality of input ports. The AWG 215 outputs a plurality of optical signals input from the input ports on the primary side of paths from respective output ports corresponding to wavelengths. In general, the AWG includes two slab waveguides and a plurality of array waveguides in which a predetermined waveguide length difference is set to connect the two slab waveguides. Thus, light input to each port of the slab waveguide on the input side is condensed on the port of the slab waveguide on the output side according to the wavelength due to dispersion caused by the phase difference given by the array waveguide.

Therefore, a plurality of user devices is connected to the input ports of the AWG 215 corresponding to respective desired wavelengths, so that the desired separation signals of all the user devices are output from a single output port. Note that an “input port of the AWG 215 corresponding to a desired wavelength” is an input port at which the desired wavelength is output from a predetermined output port. Among the plurality of output ports of the AWG 215, an output port from which an optical signal (desired signal) having a desired separation signal wavelength is output is connected to the secondary side of the path. The remaining output ports are connected to the monitoring device 130. An isolator may be provided between the separation device 170 and the monitoring device 130.

When the monitoring system 11 includes the separation device 170 according to the first configuration example, the monitoring device 130 performs configuration and monitoring processing similar to those of the first embodiment. That is, when the monitoring device 130 has the configuration illustrated in FIG. 3, the monitoring device 130 may execute the monitoring processing illustrated in FIG. 8 or the monitoring processing according to a modification thereof, and when the monitoring device 130 has the configuration illustrated in FIG. 9, the monitoring device 130 may execute the monitoring processing illustrated in FIG. 10 or the monitoring processing according to a modification thereof, and when the monitoring device 130 has the configuration illustrated in FIG. 11, the monitoring device 130 may execute the monitoring processing illustrated in FIG. 12 or the monitoring processing according to a modification thereof.

### <<Second Configuration Example of Separation Device 170>>

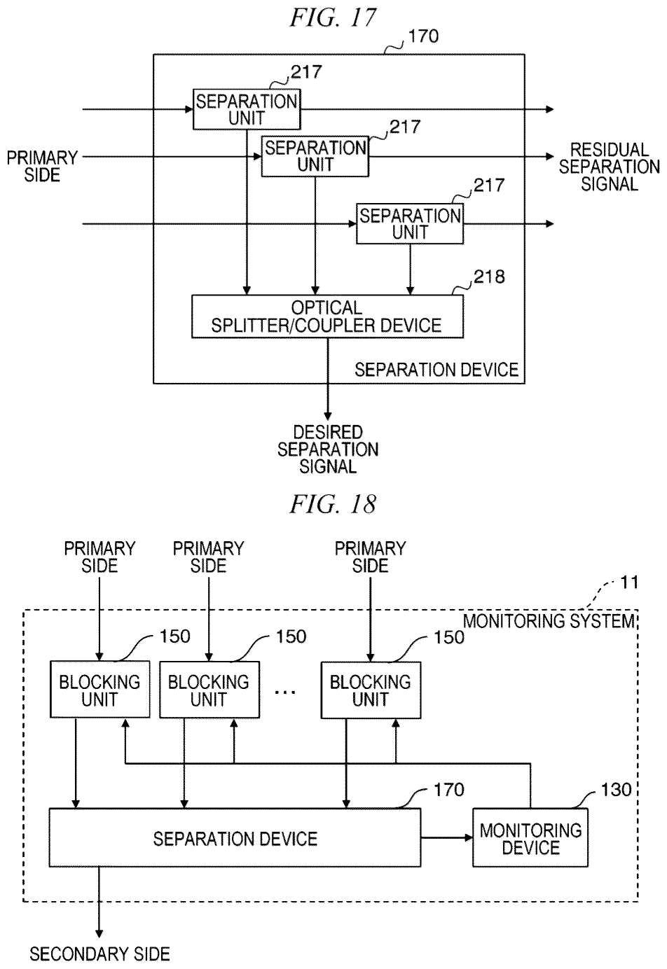

FIG. 17 is a diagram illustrating a second configuration example of the separation device 170 according to Embodiment 1-2. The separation device 170 according to the second configuration example includes a plurality of separation units 217 and an optical splitter/coupler device 218.

Input ports of the plurality of separation units 217 are connected to respective corresponding user devices. Each separation unit 217 wavelength-separates an input signal into the desired separation signal and the residual separation signal of the corresponding user device. The desired separation signal is output from the first output port of the separation unit 217, and the residual separation signal is output from the second output port of the separation unit 217. Each separation unit 217 may have, for example, a configuration similar to that of the separation unit 217 illustrated in FIGS. 4 to 7. The first output port of each separation unit 217 is connected to the input port of the optical splitter/coupler device 218. The second output port of each separation unit 217 is connected to a monitoring device. The output port of the optical splitter/coupler device 218 is connected to the secondary side of the path.

Note that, in the example illustrated in FIG. 17, the separation device 170 includes the optical splitter/coupler device 218 on the secondary side, so that light is output from one output port on the secondary side of the monitoring system 11, but the present invention is not limited thereto. For example, in another embodiment, the multiplexing unit 216 may be provided instead of the optical splitter/coupler device 218, and each separation unit 217 may be connected to an input port of the multiplexing unit 216 corresponding to a desired wavelength component. In addition, for example, when the monitoring system 11 includes a plurality of ports on the secondary side, the separation device 170 may not include the multiplexing unit 216.

Each of the second output ports of the separation device 170 according to the second configuration example outputs an excessive separation signal of the corresponding user device. Thus, when the monitoring system 11 includes the separation device 170 according to the second configuration example, the measurement unit of the monitoring device 130 can monitor the excessive separation signal for each user device without restricting the output of each user device and determine the presence or absence of the non-compliant light. That is, in this case, the monitoring device 130 may not include the optical splitter/coupler device 160 and the separation unit 217 in the configuration illustrated in FIG. 3.

Furthermore, when the optical splitter/coupler device 120 is provided for each user device in the monitoring system 11 illustrated in FIG. 2, the monitoring device illustrated in FIG. 3 may not include the optical splitter/coupler device 160, and light from the user device corresponding to the plurality of separation units 217 of the monitoring device 130 may be directly input. That is, the plurality of separation units 217 of the monitoring device 130 may function as the plurality of separation units 217 of the separation device 170.

Note that, in Embodiment 1-2, a plurality of light beams of the residual wavelength output from the separation device 170 is output to the monitoring device 130 without being multiplexed, but in another embodiment, the light beams of the residual wavelength of the separation device 170 may be multiplexed by a multiplexer/demultiplexer or an optical splitter/coupler device and output to the monitoring device 130. In this case, the monitoring device 130 may perform a configuration and monitoring processing similar to those of Embodiment 1-1. That is, when the monitoring device 130 has the configuration illustrated in FIG. 3, the monitoring device 130 may execute the monitoring processing illustrated in FIG. 8 or the monitoring processing according to a modification thereof, and when the monitoring device 130 has the configuration illustrated in FIG. 9, the monitoring device 130 may execute the monitoring processing illustrated in FIG. 10 or the monitoring processing according to a modification thereof, and when the monitoring device 130 has the configuration illustrated in FIG. 11, the monitoring device 130 may execute the monitoring processing illustrated in FIG. 12 or the monitoring processing according to a modification thereof.

### <<First Modification>>

FIG. 18 is a schematic block diagram illustrating a first modification of the monitoring system 11 according to Embodiment 1-2. In the monitoring system 11 according to the first modification, blocking units 150 are provided between the respective input ports of the separation device 170 and the user devices. Note that the blocking units 150 may be disposed near the separation device 170 as illustrated in FIG. 18, or may be disposed near the respective user devices.

Thus, the monitoring system 11 can select a user device and control whether or not the signal light can be conducted.

The restriction unit 137 of the monitoring device 130 according to the first modification may output the blocking instruction to the blocking unit 150 instead of the restriction instruction to the user device, and may output an opening instruction to the blocking unit 150 instead of the restriction release instruction to the user device. Thus, as in Embodiment 1-1, the monitoring device 130 can perform control so that unnecessary light does not flow to the secondary side of the path. Furthermore, according to the first modification, even when the user device does not follow the instruction of the monitoring device 130 and outputs an optical signal, the optical signal can be reliably blocked.

Further, when the monitoring device 130 outputs the dithering instruction and the dithering release instruction as in the third configuration example according to Embodiment 1-1, the monitoring device 130 may output the dithering instruction and the dithering release instruction to the blocking unit 150. That is, the blocking unit 150 that has received the dithering instruction superimposes modulation by the dithering component on the light input from the user device. Thus, the monitoring system 11 can dither the light output from the user device even when the user device does not follow the instruction of the monitoring device 130.

### <<Second Modification>>

The monitoring system 11 according to the second modification may include a blocking unit 150 in the subsequent stage of the separation device 170. In this case, for example, the monitoring device 130 executes monitoring processing similar to that of Embodiment 1-1, and then outputs a blocking instruction to the blocking unit 150 in the subsequent stage of the separation device 170 when the intensity of the residual separation signal remains above the non-signal threshold because the user device does not follow the restriction instruction.

### Embodiment 1-3

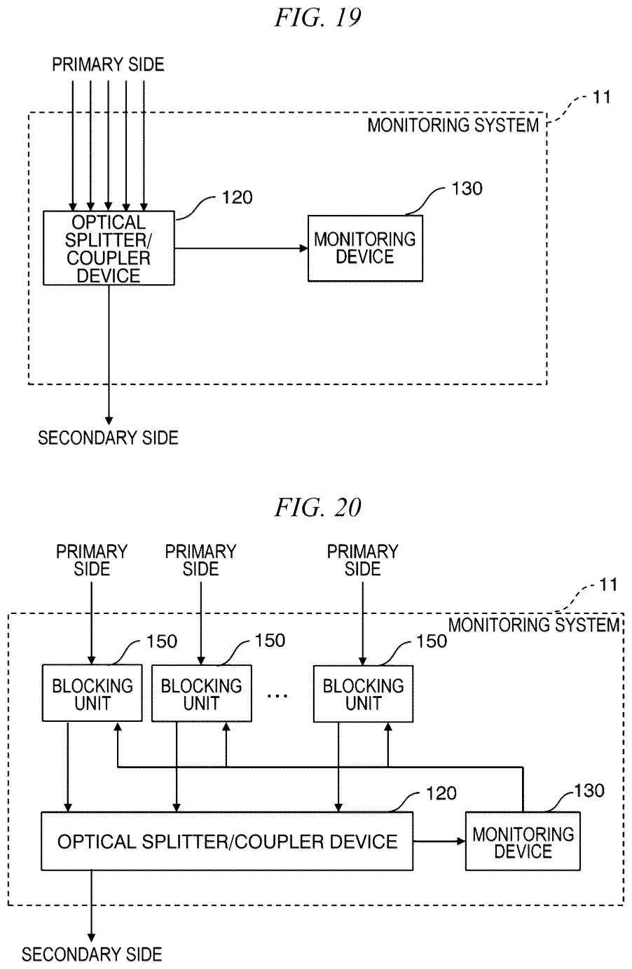

FIG. 19 is a schematic block diagram illustrating a configuration of the monitoring system 11 according to Embodiment 1-3. While the monitoring system 11 according to Embodiment 1-1 receives multiplexed light from one port on the primary side, the monitoring system 11 according to Embodiment 1-2 includes the plurality of ports on the primary side, and receives signal light from each of the plurality of user devices. As illustrated in FIG. 19, the monitoring system 11 according to Embodiment 1-3 includes the optical splitter/coupler device 120 used for multiplexing and the monitoring device 130. The optical splitter/coupler device 120 illustrated in FIG. 19 includes a plurality of input ports to which signal light is input from the user devices and two output ports.

The monitoring device 130 according to Embodiment 1-3 may have a configuration similar to that of Embodiment 1-1. That is, when the monitoring device 130 has the configuration illustrated in FIG. 3, the monitoring device 130 may execute the monitoring processing illustrated in FIG. 8 or the monitoring processing according to a modification thereof, and when the monitoring device 130 has the configuration illustrated in FIG. 9, the monitoring device 130 may execute the monitoring processing illustrated in FIG. 10 or the monitoring processing according to a modification thereof, and when the monitoring device 130 has the configuration illustrated in FIG. 11, the monitoring device 130 may execute the monitoring processing illustrated in FIG. 12 or the monitoring processing according to a modification thereof.

When the optical splitter/coupler device 120 outputs light branched from each user device to the separation unit 217 of the monitoring device 130 and also functions as the optical splitter/coupler device 160 in FIG. 3, the monitoring device 130 may not separately include the optical splitter/coupler device 160 in the configuration illustrated in FIG. 3 from the optical splitter/coupler device 120.

### <<First Modification>>

FIG. 20 is a schematic block diagram illustrating a first modification of the monitoring system 11 according to Embodiment 1-3. In the monitoring system 11 according to the first modification, the blocking units 150 are provided between the respective input ports of the optical splitter/coupler device 120 and the user devices. Note that the blocking units 150 may be disposed near the separation device 170 as illustrated in FIG. 20, or may be disposed near the respective user devices. Thus, the monitoring system 11 can select a user device and control whether or not the signal light can be conducted.

The restriction unit 137 of the monitoring device 130 according to the first modification may output the blocking instruction to the blocking unit 150 instead of the restriction instruction to the user device, and may output an opening instruction to the blocking unit 150 instead of the restriction release instruction to the user device. Thus, as in Embodiment 1-3, the monitoring device 130 can perform control so that unnecessary light does not flow to the secondary side of the path. Furthermore, according to the first modification, even when the user device does not follow the instruction of the monitoring device 130 and outputs an optical signal, the optical signal can be reliably blocked.

Further, when the monitoring device 130 outputs the dithering instruction and the dithering release instruction as in the third configuration example according to Embodiment 1-1, the monitoring device 130 may output the dithering instruction and the dithering release instruction to the blocking unit 150. That is, the blocking unit 150 that has received the dithering instruction superimposes modulation by the dithering component on the light input from the user device. Thus, the monitoring system 11 can dither the light output from the user device even when the user device does not follow the instruction of the monitoring device 130.

### <<Second Modification>>

The monitoring system 11 according to the second modification may include the blocking unit 150 in the subsequent stage of the optical splitter/coupler device 120. In this case, for example, the monitoring device 130 executes monitoring processing similar to that of Embodiment 1-1, and then outputs a blocking instruction to the blocking unit 150 in the subsequent stage of the separation device 170 when the intensity of the residual separation signal remains above the non-signal threshold because the user device does not follow the restriction instruction.

### Embodiment 1-4

FIG. 21 is a schematic block diagram illustrating a configuration of the monitoring system 11 according to Embodiment 1-4. The monitoring system 11 according to Embodiment 1-4 includes two optical splitter/coupler devices 120, a plurality of separation units 217, and the monitoring device 130. As illustrated in FIG. 21, the optical splitter/coupler device 120 is provided at a primary-side end and a secondary-side end of the monitoring system 11. The optical splitter/coupler device 120 provided on the primary side includes one input port and a plurality of output ports. In the optical splitter/coupler device 120 provided on the primary side, light input to the input port is branched and output from the plurality of output ports. The optical splitter/coupler device 120 provided on the secondary side includes a plurality of input ports and one output port. In the optical splitter/coupler device 120 provided on the secondary side, light input to the plurality of input ports is combined and output from the output port.

The plurality of separation units 217 is provided corresponding one by one to the user devices, and separate and output the input light into the desired separation signal and the residual separation signal of each user device. An input port of the separation unit 217 is connected to an output port of the optical splitter/coupler device 120 on the primary side. A first output port of the separation unit 217 is connected to an input port of the optical splitter/coupler device 120 on the secondary side. A second output port of the separation unit 217 is connected to the monitoring device 130.

The monitoring device 130 according to Embodiment 1-4 may have a configuration similar to that of Embodiment 1-1. That is, when the monitoring device 130 has the configuration illustrated in FIG. 3, the monitoring device 130 may execute the monitoring processing illustrated in FIG. 8 or the monitoring processing according to a modification thereof, and when the monitoring device 130 has the configuration illustrated in FIG. 9, the monitoring device 130 may execute the monitoring processing illustrated in FIG. 10 or the monitoring processing according to a modification thereof, and when the monitoring device 130 has the configuration illustrated in FIG. 11, the monitoring device 130 may execute the monitoring processing illustrated in FIG. 12 or the monitoring processing according to a modification thereof. #Note that the number of separation units in FIG. 21 is desirably such that coherent crosstalk generated by multiplexing the desired separation signal of a certain separation unit and the residual separation signal of another separation unit can be ignored. The coherent crosstalk may be reduced by polarization multiplexing or multiplexing with a shift of a coherent length or more.

### Embodiment 2-1

The monitoring systems 11 according to Embodiment 1-1 to Embodiment 1-4 detect a user device that outputs light having a non-compliant wavelength among the plurality of user devices connected to the path. On the other hand, the monitoring system 11 according to Embodiment 2-1 detects a user device that outputs light having a non-compliant intensity among the plurality of user devices connected to the path. As illustrated in FIG. 2, the monitoring system 11 according to Embodiment 2-1 includes the optical splitter/coupler device 120 and the monitoring device 130.

### (First Configuration Example of Monitoring Device 130)

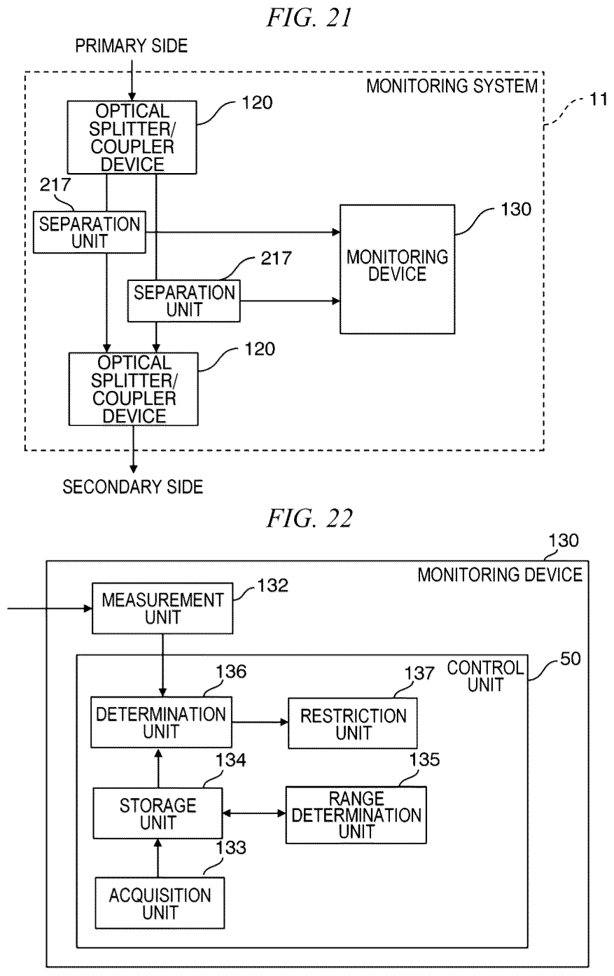

FIG. 22 is a diagram illustrating a first configuration example of the monitoring device 130 according to Embodiment 2-1. The monitoring device 130 according to Embodiment 2-1 includes a measurement unit 132 and a control unit 50. The control unit 50 functions as an acquisition unit 133, a storage unit 134, a range determination unit 135, the determination unit 136, and the restriction unit 137.

The measurement unit 132 measures the intensity of the multiplexed light output from the optical splitter/coupler device 120. For example, the measurement unit 132 may be implemented by a combination of a photoelectric conversion element such as a photodiode (PD) and an avalanche photodiode (APD) and a circuit that measures a voltage, or the like.

The acquisition unit 133 acquires setting data indicating the wavelength and intensity of an optical signal set in the user device from the management device.

The storage unit 134 stores the setting data acquired by the acquisition unit 133 and an allowable maximum value of the intensity of the multiplexed light determined by the range determination unit 135.

The range determination unit 135 determines the allowable maximum value of the intensity of the multiplexed light on the basis of setting data recorded in the storage unit 134. The allowable maximum value is calculated, for example, by multiplying the sum of the light intensities set for respective user devices connected to the path monitored by the own device by a predetermined margin rate.

When the intensities set for respective user devices by the setting data or the like indicates, for example, the maximum value of the intensity of light for preventing damage to the network device, and the user device is required to transmit light with an intensity smaller than the setting value, the margin rate may be a value less than 1 (for example, 0.8) in consideration of safety of the network device. Further, when the intensity set for each user device is set to a sufficiently small intensity in consideration of the safety of the network device, and a slight deviation is allowed in the intensity of light transmitted from the user device, the margin rate may be a value of 1 or more (for example, 1.1).

At this time, when the loss between the user device and the measurement unit 132 is known, the determination unit 136 may calculate the allowable maximum value by subtracting the loss. The allowable maximum value can be said to be an upper limit value of the allowable range of the intensity of the multiplexed light. Note that, in another embodiment, when the intensity of the optical signal is preset and known, a predetermined allowable maximum value may be stored in the storage unit 134.

When the intensity of the received light exceeds the allowable maximum value, there is a possibility that non-compliant light is included in the received multiplexed light.

The determination unit 136 determines whether or not the intensity of the multiplexed light measured by the measurement unit 132 exceeds the allowable maximum value stored in the storage unit 134. The restriction unit 137 outputs an instruction related to the output of the signal light to the user device.

Specifically, when the restriction unit 137 causes the user device to restrict the output of the signal light, the restriction unit 137 outputs a restriction instruction to the user device. The output restriction is, for example, stop of output or reduction in output intensity. When the user device is caused to release the output restriction of the signal light, a restriction release instruction is output to the user device. The restriction release is, for example, start or restart of output or an increase in output intensity. On the other hand, the instruction of the restriction unit 137 may be transmitted by communication using a predetermined carrier, may be transmitted by multiplexing the main signal by frequency division multiplexing such as AMCC (Auxiliary Management and Control Channel), time division multiplexing, or the like, or may be transmitted via a specific communication route. Further, the restriction unit 137 may issue a notification related to the output restriction to the PG or an upper device of the PG, and the PG or the upper device that has received the notification may output an instruction to the user device.

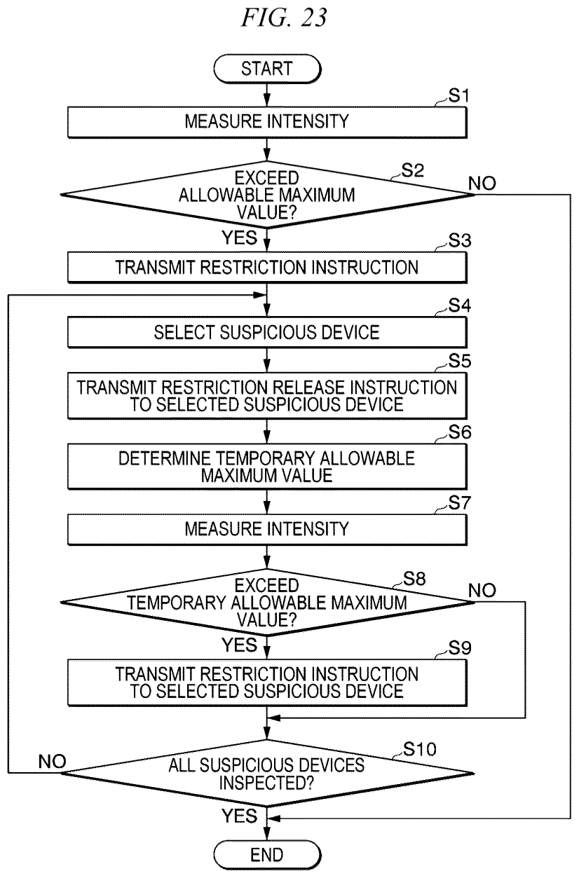

FIG. 23 is a flowchart illustrating monitoring processing by the monitoring device 130 of the first configuration example according to Embodiment 2-1.

The acquisition unit 133 of the monitoring device 130 receives the setting data from the management device by a predetermined trigger, and records the setting data in the storage unit 134. In addition, the range determination unit 135 determines the allowable maximum value from the sum of the intensities of optical signals set for the user devices connected to the path monitored by the monitoring device 130 on the basis of the setting data recorded in the storage unit 134, and records the allowable maximum value in the storage unit 134. Thereafter, the management device transmits the setting data to the monitoring device 130 every time the setting data is changed. The setting data transmitted by the management device only needs to include at least a portion related to monitoring performed by the monitoring device 130. In addition, when the intensity to be set is known or there is no change, the management device may not transmit the setting data.

Note that examples of the predetermined trigger include activation of the management device, addition of the monitoring device 130, activation of the monitoring device 130, connection, addition, deletion, and setting change of the user device, a request from the user device, setting from the management device, and the like.

The monitoring device 130 according to Embodiment 2-1 repeatedly executes the monitoring processing illustrated in FIG. 23.

The measurement unit 132 measures the intensity of the multiplexed light input from the optical splitter/coupler device 120 (step S1).

Note that, when there is a user device that has stopped outputting an optical signal, the allowable maximum value is determined on the basis of the intensity of an optical signal set in the user device that outputs the optical signal. The determination unit 136 determines whether or not the intensity of the multiplexed light measured in step S1 exceeds the allowable maximum value stored in the storage unit 134 (step S2).

When the intensity of the multiplexed light does not exceed the allowable maximum value (step S2: NO), the monitoring device 130 determines that the multiplexed light does not include non-compliant light whose intensity does not satisfy the predetermined criterion, does not restrict the optical signal, and returns the processing to step S1.

On the other hand, when the intensity of the multiplexed light exceeds the allowable maximum value (step S2: YES), the restriction unit 137 transmits a signal light restriction instruction to all the user devices (if P user devices are connected to the optical splitter/coupler device 120, the P user devices) connected to the path monitored by the monitoring device 130 (step S3). Note that the instruction need not be transmitted to stopped ones of the P user devices.

Next, the monitoring device 130 inspects the output abnormality of the plurality of user devices according to the following procedure of steps S5 to S9. The “output abnormality” refers to abnormality related to output of light having a non-compliant intensity. First, the restriction unit 137 selects one or a plurality of suspicious devices among the connected user devices (step S4) and transmits a restriction release instruction of the signal light to the suspicious device (step S5).

On the basis of the setting data recorded in the storage unit 134, the range determination unit 135 determines a temporary allowable maximum value from the sum of the intensities of the signal light set in the user device in which the output of the signal light is resumed in step S5 (step S6). The temporary allowable maximum value determined here is a temporary threshold used to search for the user device that outputs the non-compliant light, and is usually different from the allowable maximum value stored in the storage unit 134 referred to in step S3. The measurement unit 132 measures the intensity of an optical signal input from the optical splitter/coupler device 120 (step S7). The signal light received at this time is obtained by multiplexing an optical signal output from one or a plurality of suspicious devices that have resumed the output of the signal light, or an optical signal output from the user device from which the suspicion has been eliminated and an optical signal output from one or a plurality of suspicious devices.

The determination unit 136 determines whether or not the intensity of the optical signal measured in step S7 exceeds the temporary allowable maximum value determined in step S6 (step S8). When the intensity of the optical signal does not exceed the temporary allowable maximum value (step S8: NO), the determination unit 136 considers that the suspicious device selected in step S4 is normal, and does not restrict the signal light from the suspicious device. That is, the suspicion of the output abnormality is eliminated for the user device selected in step S4. On the other hand, when the intensity of the optical signal exceeds the temporary allowable maximum value (step S8: YES), the determination unit 136 determines that the user device selected in step S5 has output abnormality. When a plurality of (“A”) user devices is selected in step S4, the determination unit 136 may select one user device or less than “A” user devices and perform the processing from step S5 in order to determine which of the plurality of user devices has output abnormality.

The restriction unit 137 again transmits the signal light restriction instruction to the user device in which the output abnormality is found (step S9).

The monitoring device 130 determines whether or not there are any uninspected suspicious devices (step S10). When any uninspected suspicious devices remain (step S10: NO), the monitoring device 130 returns the processing to step S4 and inspects the remaining suspicious device. On the other hand, when there is no more uninspected suspicious device (step S10: YES), the processing returns to step S1.

Note that, in the flow illustrated in FIG. 23, since the user device that is no longer suspicious in step S8 remains outputting the optical signal, the temporary allowable maximum value in step S7 may change every time the loop from step S4 to step S10 is repeated. On the other hand, the present invention is not limited to this in other embodiments.

For example, the intensities assigned to all the user devices are the same, the user devices may be set as suspicious devices one by one, whether or not the suspicious devices are non-compliant may be recorded on the basis of the determination in step S8, the restriction instruction in S9 may be transmitted regardless of whether or not the suspicion is eliminated, and after it is determined in step S10 that there is no more uninspected suspicious device, the restriction release instruction may be transmitted to the device recorded as not non-compliant, and the processing may be terminated. In this case, the temporary allowable maximum value does not change in the loop from step S4 to step S10. Further, in another embodiment, the restriction instruction may not be issued in step S4, the restriction instruction may be transmitted instead of the restriction release instruction in step S5, and the restriction release instruction may be transmitted instead of the restriction instruction in step S9. Furthermore, in another embodiment, the restriction instruction in step S4 may not be issued, the restriction instruction may be transmitted instead of the output instruction in step S5, whether or not the suspicious device is non-compliant may be recorded on the basis of the determination in step S8, the restriction release instruction may be transmitted instead of the restriction instruction in step S9 regardless of whether or not the suspicion is eliminated, and the restriction instruction may be output to the device recorded as non-compliant in step S8 when it is determined in step S10 that there is no more uninspected suspicious device, and the processing may be terminated.

Note that the measurement unit 132 of the monitoring device 130 according to the first configuration example measures the intensity of the light branched from the optical splitter/coupler device 120, but the present invention is not limited thereto. For example, the measurement unit 132 may measure the intensity of the desired separation signal or the residual separation signal. In this case, as illustrated in FIG. 3, the monitoring device 130 may include the optical splitter/coupler device 120 and the plurality of separation units 217 in the preceding stage of the measurement unit 132. In this case, the measurement unit 132 may switch light to be measured out of light output from the plurality of separation units 217 in a time division manner.

### (Second Configuration Example of Monitoring Device 130)

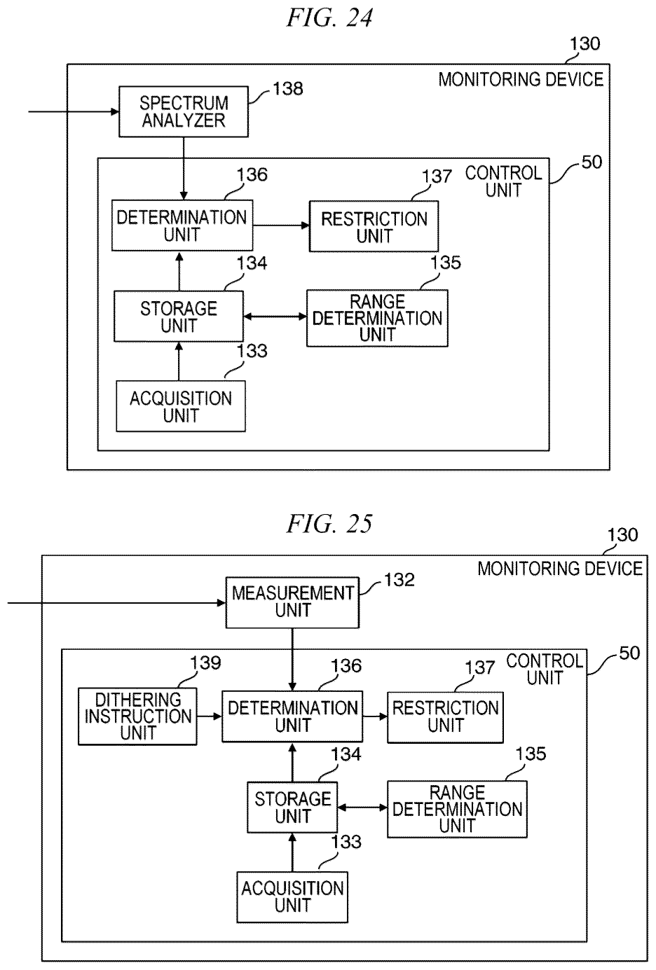

FIG. 24 is a diagram illustrating a second configuration example of the monitoring device 130 according to Embodiment 2-1. The monitoring device 130 according to the second configuration example includes the spectrum analyzer 138 instead of the measurement unit 132 of the first configuration example. Other configurations of the monitoring device 130 according to the second configuration example are similar to those of the first configuration example. The spectrum analyzer 138 measures the distribution of wavelength components included in the received signal, that is, the relationship between the wavelength and the intensity.

In the monitoring device 130 according to the second configuration example, steps S1 and S2, and steps S7 and S8 illustrated in FIG. 23 are different from those in the first configuration example. Specifically, it is as follows.

In step S1, the spectrum analyzer 138 measures the distribution of wavelength components of the signal branched from the optical splitter/coupler device 120. In step S2, the determination unit 136 determines whether or not there are one or more wavelengths whose intensity exceeds the non-signal threshold on the basis of the distribution of the wavelength components of the signal branched from the optical splitter/coupler device 120.

In step S7, the spectrum analyzer 138 measures the distribution of the wavelength components of the signal branched from the optical splitter/coupler device 120. In step S8, the determination unit 136 determines whether or not there are one or more wavelengths whose intensity exceeds the non-signal threshold on the basis of the distribution of the wavelength components of the signal branched from the optical splitter/coupler device 120.

Note that, as in the first configuration example, the monitoring device 130 according to another embodiment may terminate the processing by transmitting the restriction release instruction to a device recorded as not non-compliant after it is determined that there is no more uninspected suspicious device. In addition, the monitoring device according to another embodiment may transmit the restriction instruction instead of the restriction release instruction in step S5 without issuing the restriction instruction in step S4, and may transmit the restriction release instruction instead of the restriction instruction in step S9. In addition, the monitoring device 130 according to another embodiment may not issue the restriction instruction in step S4, may transmit the restriction instruction instead of the output instruction in step S5, record whether or not the suspicious device is non-compliant on the basis of the determination in step S8, transmit the restriction release instruction instead of the restriction instruction in step S9 regardless of whether or not the suspicion is eliminated, output the restriction instruction to the device recorded as non-compliant in step S8 when it is determined in step S10 that there is no more uninspected suspicious device, and terminate the processing.

### (Third Configuration Example of Monitoring Device 130)

FIG. 25 is a diagram illustrating a third configuration example of the monitoring device 130 according to Embodiment 2-1. The monitoring device 130 according to the third configuration example further includes the dithering instruction unit 139 in addition to the configuration of the first configuration example. Other configurations of the monitoring device 130 according to the third configuration example are similar to those of the first configuration example. The dithering instruction unit 139 outputs a dithering instruction and a dithering release instruction to the user device. The dithering instruction is an instruction to perform modulation with a frequency or a time-series pattern different for each user device. Hereinafter, a frequency or a time-series pattern for modulating the optical signal by the dithering instruction is referred to as a dithering component.

With the dithering component, it is possible to uniquely identify the user device that is the transmission source of the optical signal modulated with the dithering component. On the other hand, the dithering release instruction is an instruction to cause the user device to stop the modulation of the optical signal with the dithering component.

Further, the measurement unit 132 according to the third configuration example has a function of extracting the intensity of the dithering component of each user device from the reception intensity of the optical signal. When the dithering component is a frequency, the measurement unit 132 extracts the intensity of a frequency component, and when the dithering component is a pattern, the measurement unit 132 extracts the intensity of a component corresponding to the pattern. The measurement unit 132 according to the third configuration example includes, for example, a lock-in amplifier.

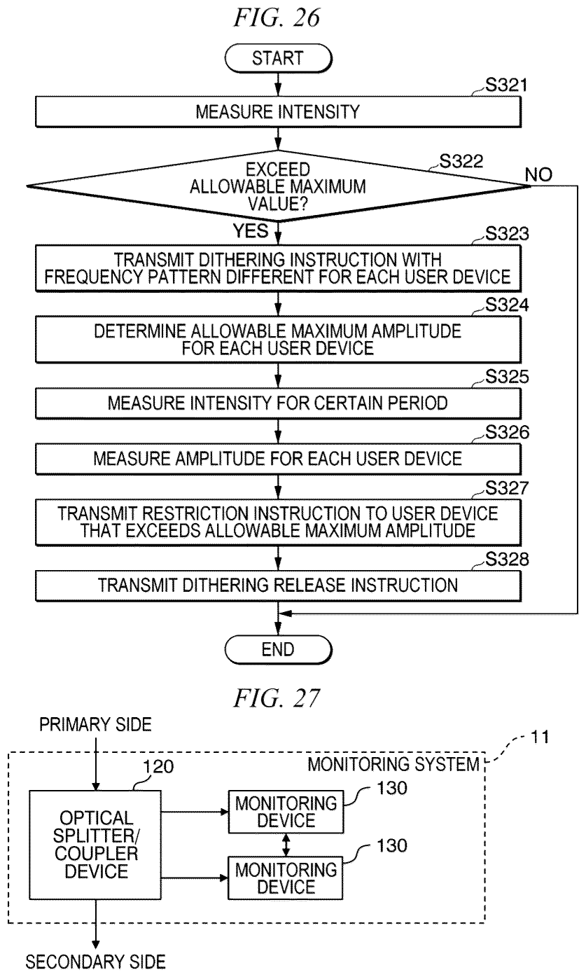

FIG. 26 is a flowchart illustrating monitoring processing by the monitoring device 130 of the third configuration example according to Embodiment 2-1.

The acquisition unit 133 of the monitoring device 130 receives the setting data from the management device by a predetermined trigger, and records the setting data in the storage unit 134. Thereafter, the management device transmits the setting data to the monitoring device 130 every time the setting data is changed.

The monitoring device 130 according to the third configuration example repeatedly executes the monitoring processing illustrated in FIG. 26. The measurement unit 132 measures the intensity of the multiplexed light input from the optical splitter/coupler device 120 (step S321). The determination unit 136 determines whether or not the intensity of the multiplexed light measured in step S321 exceeds the allowable maximum value recorded in the storage unit 134 (step S322).

When the intensity of the multiplexed light does not exceed the allowable maximum value (step S322: NO), the monitoring device 130 determines that the non-compliant light is not included in the multiplexed light, does not restrict the optical signal, and returns the processing to step S321.

On the other hand, when the intensity of the multiplexed light exceeds the allowable maximum value (step S322: YES), the dithering instruction unit 139 determines different patterns for all the user devices connected to the path monitored by the monitoring device 130, and transmits a dithering instruction with the determined pattern to each user device (step S323). Examples of the modulation pattern include a modulation pattern in which the intensity of the optical signal is changed at different frequencies for each user device. At this time, the dithering instruction unit 139 determines the frequencies of the user devices to be frequencies that are not multiples or divisors of each other. As another example of the modulation pattern, the intensity or the wavelength of the optical signal is changed at different timings for each user device. At this time, the dithering instruction unit 139 determines timings at which the intensity of each user device is changed to timings that do not overlap each other.

The determination unit 136 determines an allowable maximum amplitude of the dithering component for each user device on the basis of the magnitude of the amplitude related to the dithering (step S324).

Next, the measurement unit 132 measures the intensity of the multiplexed light input from the optical splitter/coupler device 120 for a certain period (step S325). The measurement unit 132 measures the amplitude of each dithering component of the frequency set in each user device from the time series of the intensity of the multiplexed light in the certain period (step S326). Note that the measurement unit 132 may simultaneously measure the amplitude of the dithering component for each user device, or may individually select and measure a frequency or time-series pattern for each user device.

Next, the determination unit 136 specifies a dithering component whose amplitude exceeds the allowable maximum amplitude determined in step S324 on the basis of the amplitude of each dithering component measured in step S326 among the plurality of user devices.

The restriction unit 137 transmits a signal light restriction instruction to the specified user device (step S327). Thus, the output of the optical signal by the user device that outputs the non-compliant light can be stopped. Then, the dithering instruction unit 139 transmits a dithering release signal to another user device (step S328).

As described above, the monitoring device 130 according to the third configuration example can specify the user device that outputs the non-compliant light by observing the dithering component while maintaining the output of the optical signal to the user device.

### <<Operations and Effects>>

As described above, when the intensity of the received multiplexed light exceeds the allowable range according to the signal intensity set in advance in the user device, the monitoring device 130 according to Embodiment 2-1 performs control so that the optical signal does not flow by transmitting a stop signal to the user device. Thus, the monitoring device 130 can perform control so that the non-compliant light is not conducted.

Note that, according to Embodiment 2-1, each of the user devices operates in accordance with the restriction instruction and the restriction release instruction from the monitoring device 130, so that it is possible to control the non-compliant light not to be conducted. On the other hand, even when some user devices do not follow the restriction instruction and the restriction release instruction, the monitoring device 130 can control the non-compliant light from other user devices not to be conducted. For example, when there is only one user device of abnormal output and this user device of abnormal output does not follow, when a restriction signal is transmitted to each user device in step S4, the user devices other than the user device of abnormal output stop the output according to the restriction signal, and only the user device of abnormal output does not stop the output. Thus, the monitoring device 130 can determine the output of the user device of normal output by measuring the intensity of the light after transmitting the restriction instruction in step S4 and determining the temporary allowable maximum value on the basis of the difference from the intensity. Note that, when the user device of normal output does not follow the instruction, even if there is a plurality of user devices that do not follow the instruction, the user devices can be identified. In this case, the monitoring device 130 needs to recognize whether or not the user device follows the instruction by an acknowledgement or the like to the user device.

### <<First Modification>>

The monitoring system 11 according to the first modification of Embodiment 2-1 detects a user device that outputs light having a non-compliant intensity among a plurality of user devices connected to the path. Furthermore, the monitoring system 11 according to the first modification performs control so that an optical signal is not conducted to the secondary side of the path when an optical signal passing through the path includes light having a non-compliant intensity.

As illustrated in FIG. 13, the monitoring system 11 according to the first modification of Embodiment 2-1 includes a blocking unit 150 in the subsequent stage of the port on the secondary side of the optical splitter/coupler device 120. The blocking unit 150 switches between passing and blocking of an input optical signal in accordance with an instruction from the monitoring device 130.

The monitoring device 130 according to the first modification of Embodiment 2-1 performs the following processing in addition to the monitoring processing of Embodiment 2-1. The restriction unit 137 of the monitoring device 130 outputs the blocking instruction to the blocking unit 150 when the intensity of the signal branched from the optical splitter/coupler device 120 exceeds the allowable maximum value. Thus, the blocking unit 150 blocks the optical signal output from the optical splitter/coupler device 120.

Further, the restriction unit 137 of the monitoring device 130 outputs the opening instruction to the blocking unit 150 after the intensity of the signal branched from the optical splitter/coupler device 120 does not exceed the allowable maximum value. Thus, the blocking unit 150 conducts the optical signal output from the optical splitter/coupler device 120 to the secondary side of the path.

As described above, since the monitoring device 130 according to the first modification includes the blocking unit 150, even when the user device does not follow the instruction of the monitoring device 130 and outputs an optical signal, it is possible to reliably prevent the optical signal from being conducted. Note that, when the user device 20 that outputs light whose intensity is non-compliant does not follow the restriction instruction, not only the signal light of the user device 20 but also the signal light of other user devices 20 remains blocked.

### <<Second Modification>>

According to the second modification, as illustrated in FIG. 14, the blocking unit 150 of the monitoring system 11 may be provided in the preceding stage of the separation unit 217. In this case, when the blocking unit 150 blocks the signal light, the signal light is not input to the monitoring device 130. Thus, the monitoring device 130 executes monitoring processing similar to that of Embodiment 2-1, for example, and then outputs a blocking instruction to the blocking unit 150 when the intensity of the signal light remains above the allowable maximum value because the user device does not follow the restriction instruction.

### Embodiment 2-2

While the monitoring system 11 according to Embodiment 2-1 receives multiplexed light from one port on the primary side, the monitoring system 11 according to Embodiment 2-2 includes a plurality of ports on the primary side, and receives signal light from each of a plurality of user devices. As illustrated in FIG. 19, the monitoring system 11 according to Embodiment 2-2 includes the optical splitter/coupler device 120 used for multiplexing and the monitoring device 130. The optical splitter/coupler device 120 illustrated in FIG. 19 includes a plurality of input ports to which signal light is input from the user devices and two output ports.

The monitoring device 130 according to Embodiment 2-2 may have a configuration similar to that of Embodiment 2-1. That is, when the monitoring device 130 has the configuration illustrated in FIG. 22, the monitoring device 130 may execute the monitoring processing illustrated in FIG. 23 or the monitoring processing according to a modification thereof, and when the monitoring device 130 has the configuration illustrated in FIG. 24, the monitoring device 130 may execute the monitoring processing illustrated in FIG. 23 or the monitoring processing according to a modification thereof, and when the monitoring device 130 has the configuration illustrated in FIG. 25, the monitoring device 130 may execute the monitoring processing illustrated in FIG. 26 or the monitoring processing according to a modification thereof.

### <<First Modification>>

With the monitoring system 11 according to the first modification of Embodiment 2-2, as illustrated in FIG. 20, the blocking units 150 are provided between the respective input ports of the optical splitter/coupler device 120 and the user devices. Note that the blocking units 150 may be disposed near the separation device 170 as illustrated in FIG. 20, or may be disposed near the respective user devices. Thus, the monitoring system 11 can select a user device and control whether or not the signal light can be conducted.

The restriction unit 137 of the monitoring device 130 according to the first modification may output the blocking instruction to the blocking unit 150 instead of the restriction instruction to the user device, and may output an opening instruction to the blocking unit 150 instead of the restriction release instruction to the user device. Thus, as in Embodiment 1-3, the monitoring device 130 can perform control so that unnecessary light does not flow to the secondary side of the path. Furthermore, according to the first modification, even when the user device does not follow the instruction of the monitoring device 130 and outputs an optical signal, the optical signal can be reliably blocked.

Further, when the monitoring device 130 outputs the dithering instruction and the dithering release instruction as in the third configuration example according to Embodiment 2-1, the monitoring device 130 may output the dithering instruction and the dithering release instruction to the blocking unit 150.

### <<Second Modification>>

The monitoring system 11 according to the second modification may include the blocking unit 150 in the subsequent stage of the optical splitter/coupler device 120. In this case, for example, the monitoring device 130 executes monitoring processing similar to that of Embodiment 2-1, and then outputs a blocking instruction to the blocking unit 150 in the subsequent stage of the separation device 170 when the intensity of the residual separation signal remains above the non-signal threshold because the user device does not follow the restriction instruction.

### Embodiment 3

The monitoring systems 11 according to Embodiment 1-1 to Embodiment 1-4 detect a user device that outputs light having a non-compliant wavelength. Further, the monitoring systems 11 according to Embodiment 2-1 and Embodiment 2-2 detect a user device that outputs light having a non-compliant intensity. On the other hand, the monitoring system 11 according to Embodiment 3 can detect both the user device that outputs the light having a non-compliant wavelength and the user device that outputs the light having the non-compliant intensity.

FIG. 27 is a diagram illustrating a configuration of the monitoring system 11 according to a first configuration example of Embodiment 3. The monitoring system 11 according to the first configuration example of Embodiment 3 has the configuration illustrated in FIG. 27. That is, the monitoring device 130 according to the first configuration example of Embodiment 3 includes the optical splitter/coupler device 120 and two monitoring devices 130A and 130B. The monitoring device 130A has a configuration similar to that of the monitoring device 130 according to Embodiment 1-1. That is, the monitoring device 130A may have the configuration illustrated in FIG. 3, FIG. 9, or FIG. 11. The monitoring device 130B has a configuration similar to that of the monitoring device 130 according to Embodiment 2-1. That is, the monitoring device 130B may have the configuration illustrated in FIG. 22, FIG. 24, or FIG. 25. Note that the monitoring device 130A and the monitoring device 130B may share the control unit 50.

For example, the monitoring device 130 has the configuration of FIG. 3, and the control unit 50 regards values obtained by the measurement unit 132 illustrated in FIG. 3 measuring both a desired separation wavelength and a residual separation wavelength as values obtained by the measurement unit 132 of FIG. 22. Such a configuration is suitable, for example, when using an AWG or the like in which a 3 dB band extends to an intermediate wavelength with an adjacent wavelength.

Further, when the monitoring device 130A and the monitoring device 130B include the spectrum analyzer 138, the monitoring system 11 may include only one monitoring device 130 as illustrated in FIG. 2.

### <<First Operation Example of Monitoring Device 130>>

In the monitoring system 11 according to Embodiment 3, in a predetermined monitoring cycle, the monitoring device 130A detects the presence or absence of light having a non-compliant wavelength, and the monitoring device 130B detects light having a non-compliant intensity. For example, first, the monitoring device 130A executes the monitoring processing described in Embodiment 1-1, and after the monitoring processing of the monitoring device 130A, the monitoring device 130B executes the monitoring processing described in Embodiment 2-1. For example, the monitoring device 130B may first execute the monitoring processing described in Embodiment 2-1, and the monitoring device 130A may execute the monitoring processing described in Embodiment 1-1 after the monitoring processing of the monitoring device 130B.

### <<Second Operation Example of Monitoring Device 130>>

The monitoring system 11 according to Embodiment 3 may perform detection of light having a non-compliant wavelength and detection of light having a non-compliant intensity in parallel.

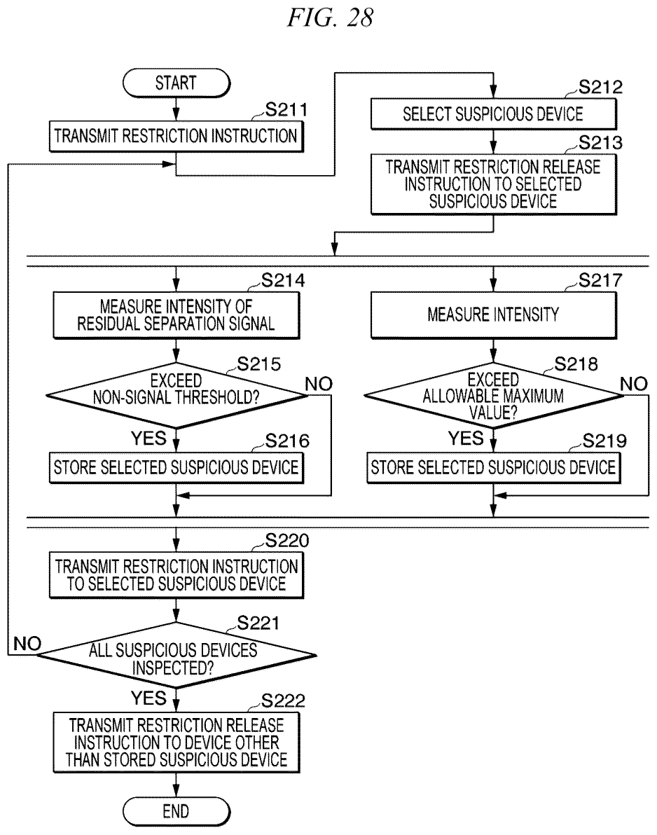

FIG. 28 is a flowchart illustrating monitoring processing by the monitoring system 11 according to Embodiment 3. In this example, the description will be given assuming that the monitoring device 130A has the configuration illustrated in FIG. 3 and the monitoring device 130B has the configuration illustrated in FIG. 22.

The acquisition unit 133 of the monitoring device 130B receives setting data from the management device by a predetermined trigger, and records the setting data in the storage unit 134. In addition, the range determination unit 135 determines the allowable maximum value for each wavelength from the wavelength and the intensity of an optical signal set in the user device connected to the path monitored by the monitoring device 130 on the basis of the setting data recorded in the storage unit 134, and records the determined allowable maximum value in the storage unit 134. For example, the range determination unit 135 can determine the allowable maximum value for each wavelength by calculating, for each wavelength, the sum of the intensities of optical signals allocated to the wavelength in the setting data. Thereafter, the management device transmits the setting data to the monitoring device 130 every time the setting data is changed.

The monitoring system 11 according to Embodiment 3 executes the monitoring processing illustrated in FIG. 28 every predetermined monitoring cycle. The restriction unit 137 of the monitoring device 130A transmits a signal light restriction instruction to all the user devices connected to the path monitored by the monitoring device 130 (step S211).

Next, the restriction unit 137 of the monitoring device 130A selects one of the suspicious devices (step S212), and transmits a restriction release instruction of the signal light to the suspicious device (step S213). At this time, the monitoring device 130A notifies the monitoring device 130B of identification information of the selected suspicious device. Thus, the monitoring device 130A and the monitoring device 130B can share information on the selected suspicious device. Thereafter, the monitoring device 130A and the monitoring device 130B perform detection processing of the non-compliant light in parallel. That is, the following processing from step S214 to step S216 and the following processing from step S217 to step S219 are executed in parallel.

The measurement unit 132 of the monitoring device 130A measures the intensity of the residual separation signal input from the separation unit 217 corresponding to the selected user device (step S214). The determination unit 136 of the monitoring device 130A determines whether or not the intensity of the residual separation signal measured in step S214 exceeds the non-signal threshold (step S215). When the intensity of the residual separation signal does not exceed the non-signal threshold (step S215: NO), the determination unit 136 of the monitoring device 130A determines that the user device selected in step S212 is normal. On the other hand, when the intensity of the residual separation signal exceeds the non-signal threshold (step S215: YES), the determination unit 136 of the monitoring device 130A determines that the user device selected in step S212 has wavelength abnormality. The restriction unit 137 of the monitoring device 130A stores the ID of the user device selected in step S212 in the internal memory (step S216).

The measurement unit 132 of the monitoring device 130B measures the intensity of an optical signal input from the optical splitter/coupler device 120 (step S217). The determination unit 136 of the monitoring device 130B determines whether or not the intensity of the optical signal measured in step S217 exceeds the allowable maximum value (step S218). When the intensity of the optical signal does not exceed the allowable maximum value (step S218: NO), the determination unit 136 of the monitoring device 130B determines that the suspicious device selected in step S212 is normal. On the other hand, when the intensity of the optical signal exceeds the allowable maximum value (step S218: YES), the determination unit 136 of the monitoring device 130B determines that the user device selected in step S212 has output abnormality. The restriction unit 137 of the monitoring device 130B notifies the monitoring device 130A that the user device selected in step S212 has output abnormality. The restriction unit 137 of the monitoring device 130A stores the notified ID of the user device in the internal memory (step S219).

The monitoring device 130A and the monitoring device 130B communicate with each other and notify that the detection processing of non-compliant for the suspicious device selected in step S212 is finished. In each of the monitoring device 130A and the monitoring device 130B, when it is determined whether or not the user device selected in step S152 is normal, the restriction unit 137 of the monitoring device 130A transmits a restriction instruction to the user device (step S220).

The monitoring device 130A determines whether or not there are any uninspected suspicious devices (step S221). When any uninspected suspicious devices remain (step S221: NO), the monitoring device 130A returns the processing to step S212 and inspects the remaining suspicious device. On the other hand, when there is no more uninspected suspicious device, the monitoring device 130A transmits a restriction release instruction to the user device other than the user devices stored in step S216 and step S219 (step S222), and terminates the processing.

Note that the processing of the monitoring system 11 is not limited to the monitoring processing illustrated in FIG. 28. For example, when the configurations of the monitoring device 130A and the monitoring device 130B are different from each other, for example, when the monitoring device 130 includes a spectrum analyzer, the processing based on the distribution of the wavelength component is performed as illustrated in FIG. 10, and when the dithering instruction unit 139 is included, detection of non-compliant light is performed on the basis of the dithering component as illustrated in FIG. 12. Further, in the monitoring processing described above, the monitoring device 130A transmits an instruction to the user device, but the present invention is not limited thereto, and the monitoring device 130B may transmit an instruction.

Further, in another embodiment, the restriction instruction may not be issued in step S211, the restriction instruction may be transmitted only to the suspicious device selected instead of the restriction release instruction in step S213, the light may be determined to be non-compliant light when a change in the measured value of the intensity before and after the transmission of the restriction instruction exceeds the non-signal threshold in step S215, and the light may be determined to be non-compliant light when a change in the measured value of the intensity before and after the transmission of the restriction instruction exceeds the allowable maximum value in step S218.

### <<First Modification>>

The monitoring system 11 according to a first modification of Embodiment 3 detects a user device that outputs non-compliant light among a plurality of user devices connected to the path. Furthermore, the monitoring system 11 according to the first modification performs control so that an optical signal is not conducted to the secondary side of the path when non-compliant light is included in the optical signal passing through the path.

As illustrated in FIG. 13, the monitoring system 11 according to the first modification of Embodiment 3 includes the blocking unit 150 in the subsequent stage of the port on the secondary side of the optical splitter/coupler device 120. The blocking unit 150 switches between passing and blocking of an input optical signal in accordance with an instruction from the monitoring device 130.

The monitoring device 130 according to the first modification of Embodiment 3 performs the following processing in addition to the monitoring processing of Embodiment 3. The restriction unit 137 of the monitoring device 130A outputs a blocking instruction to the blocking unit 150 when the intensity of the residual separation signal separated from the separation unit 217 exceeds the non-signal threshold. Further, the restriction unit 137 of the monitoring device 130B outputs the blocking instruction to the blocking unit 150 when the intensity of the signal branched from the optical splitter/coupler device 120 exceeds the allowable maximum value. Thus, the blocking unit 150 blocks the optical signal output from the optical splitter/coupler device 120.

In addition, the restriction unit 137 of the monitoring device 130 outputs the opening instruction to the blocking unit 150 after the intensity of the residual separation signal does not exceed the non-signal threshold and the intensity of the signal does not exceed the allowable maximum value. Thus, the blocking unit 150 conducts the optical signal output from the optical splitter/coupler device 120 to the secondary side of the path.

As described above, since the monitoring device 130 according to the first modification includes the blocking unit 150, even when the user device does not follow the instruction of the monitoring device 130 and outputs an optical signal, it is possible to reliably prevent the optical signal from being conducted. Note that, when the user device 20 that outputs light whose intensity is non-compliant does not follow the restriction instruction, not only the signal light of the user device 20 but also the signal light of other user devices 20 remains blocked.

### <<Second Modification>>

According to the second modification, as illustrated in FIG. 14, the blocking unit 150 of the monitoring system 11 may be provided in the preceding stage of the separation unit 217. In this case, when the blocking unit 150 blocks the signal light, the signal light is not input to the monitoring device 130. Thus, the monitoring device 130 executes monitoring processing similar to that of Embodiment 3, for example, and then outputs a blocking instruction to the blocking unit 150 when the intensity of the residual separation signal exceeds the non-signal threshold or the intensity of the signal light remains above the allowable maximum value because the user device does not follow the restriction instruction.

### FOURTH EMBODIMENT

In Embodiment 4, an optical cross connect system 10 including a monitoring system 11 will be described.

The optical cross connect system 10 is a system that outputs a desired signal from the input optical signals and routes the signal to a destination. The optical cross connect system 10 is used, for example, as a component of a PG (Photonic Gateway). Hereinafter, the optical cross connect system 10 used for the PG will be described.

A single or a plurality of user devices 20, a transmission path, or another network is connected to the PG. The PG or a host device of the PG according to the fourth embodiment sets a wavelength and an intensity used for communication for each user device. The host device of the PG is a device that controls a network including the PG as a component. That is, the PG or the upper device of the PG is an example of the management device. Note that the PG or the host device according to another embodiment may set only the wavelength in the user device 20 and may not set the intensity. In a case where the intensity is not set, the user device 20 outputs an optical signal in a range of a predetermined intensity. Each user device 20 under control of the PG transmits an optical signal according to the set wavelength and intensity. The optical signal input from each user device 20 or the transmission path or another network is transmitted to each user device 20 or the transmission path or another network of an appropriate destination by the PG.

### <<Configuration of Optical Cross Connect System>>

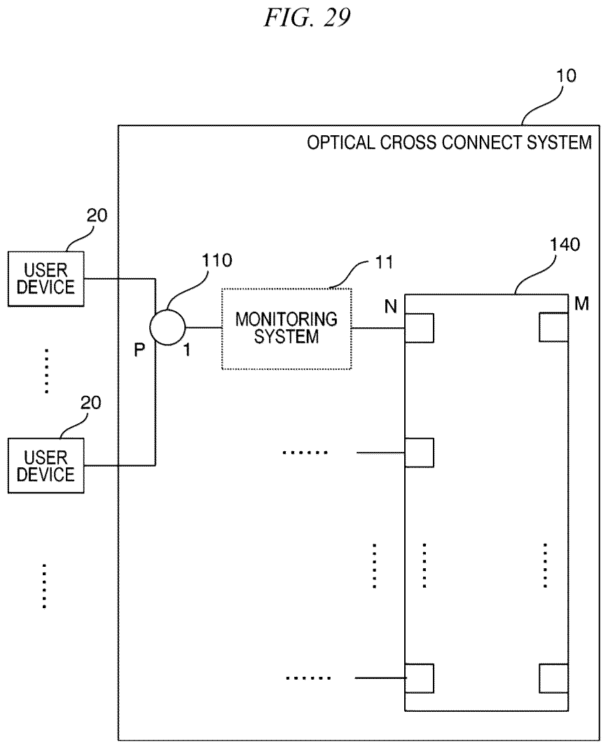

FIG. 29 is a schematic diagram illustrating a configuration of the optical cross connect system according to Embodiment 4. The optical cross connect system 10 includes an optical splitter/coupler device 110, the monitoring system 11, and an optical cross connect device 140. The optical cross connect device 140 includes N ports on the primary side and M ports on the secondary side. One optical splitter/coupler device 110 and one monitoring system 11 are provided at each of the ports on the primary side of the optical cross connect device 140. The monitoring system 11 illustrated in FIG. 29 may have the configuration of any of the above-described embodiments. However, when the monitoring system includes a plurality of input ports corresponding to the user device as illustrated in FIGS. 15 and 19, the optical splitter/coupler device 110 may not be provided. Note that the optical cross connect system illustrated in FIG. 29 is an example of a transparent network. In Embodiment 4, a case where the monitoring system 11 is applied to an optical cross connect system will be described, but in another embodiment, the monitoring system 11 may monitor another transparent network.

The optical splitter/coupler device 110 includes P ports on the primary side and at least one port on the secondary side.

A user device 20 is connected to each of the ports on the primary side of the optical splitter/coupler device 110. Note that, when a transmission path or another network is connected, a device that transmits to the port corresponds to the user device.

That is, the optical cross connect system 10 is configured to be connectable to P x N user devices 20. Note that the number P of ports on the primary side of the optical splitter/coupler devices 110 may be different for each of the N optical splitter/coupler devices 110. To a port on the primary side of the monitoring system 11, a port on the secondary side of the optical splitter/coupler device 110 is connected directly or via a transmission path. To a port on the primary side of the optical cross connect device 140, a port on the secondary side of the monitoring system 11 is connected.

That is, in Embodiment 4, input P optical signals are merged by the optical splitter/coupler device 110 and the optical splitter/coupler device 120, and the merged signal is branched into two optical signals at a predetermined branching ratio and output.

The optical cross connect device 140 routes an optical signal input to the port on the primary side to the port corresponding to a destination of the optical signal. Note that, since a normal switch does not have a configuration for connecting ports on the same side, the optical cross connect device 140 may provide a return transmission path for connecting two different ports on the same side and implement transmission between user devices connected to the same side of the switch. That is, when the port A and the port B on the same side of the switch are connected by the return transmission path and the optical signal is transmitted from the port C to the port D on the opposite side, the optical cross connect device 140 can transmit the optical signal from the port C to the port D on the same side by controlling so that the port A and the port C are connected and the port B and the port D are connected. In addition, the optical cross connect device 140 may include a special switch capable of connecting ports on the same side.

### OTHER EMBODIMENTS

Although embodiments have been described in detail with reference to the drawings, specific configurations are not limited to the above-described configurations, and various design changes and the like can be made thereto. That is, in other embodiments, the order of the above-described processing may be changed as appropriate. Further, part of the processing may be executed in parallel.

The monitoring device 130 according to the above-described embodiment may be configured by a single computer, or the configuration of the monitoring device 130 may be divided into a plurality of computers and the plurality of computers may function as the monitoring device 130 in cooperation with each other. In addition, the monitoring device 130 according to the above-described embodiment is provided in the optical cross connect system 10, but is not limited thereto. For example, the monitoring device 130 may monitor a communication path other than the optical cross connect system 10. Furthermore, for example, in another embodiment, a combination of the monitoring device 130 and the blocking unit 150 may monitor a communication path other than the optical cross connect system 10.

### <Computer Configuration>

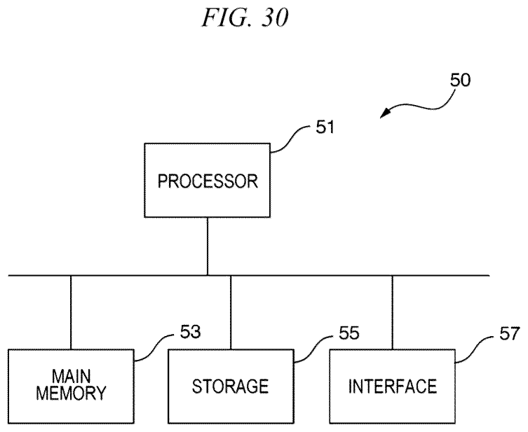

FIG. 30 is a schematic block diagram illustrating a configuration of the control unit 50 according to at least one embodiment.

The control unit 50 includes a processor 51, a main memory 53, a storage 55, and an interface 57.

The above-described control unit 50 may be implemented in a computer. In this case, the operation of each processing unit described above is stored in the storage 55 in the form of a program. The processor 51 reads the program from the storage 55, develops the program in the main memory 53, and executes the above processing according to the program. In addition, the processor 51 secures a storage area corresponding to each of the above-described storage units in the main memory 53 according to the program. Examples of the processor 51 include a central processing unit (CPU), a graphic processing unit (GPU), and a microprocessor.

The program may be for implementing a part of the functions to be exerted by the control unit 50. For example, the program may exhibit the functions by a combination with another program already stored in the storage or a combination with another program mounted on another device. Note that, in another embodiment, the control unit 50 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions implemented by the processor 51 may be implemented by the integrated circuit. Such an integrated circuit is also included in the examples of the processor.

Examples of the storage 55 include a magnetic disk, a magneto-optical disk, an optical disk, a semiconductor memory, and the like. The storage 55 may be an internal medium directly connected to a bus or an external medium connected to the control unit 50 via the interface 57 or a communication line. Further, when this program is distributed to the control unit 50 via a communication line, the control unit 50 that has received the distribution may expand the program in the main memory 53 and execute the above processing. In at least one embodiment, the storage 55 is a non-transitory tangible storage medium.

In addition, the program may be for implementing a part of the functions described above. Furthermore, the program may be a program that implements the above-described functions in combination with another program already stored in the storage 55, that is, what is called a difference file (difference program).

### REFERENCE SIGNS LIST

10 Optical cross connect system
11 Monitoring system
110 Optical splitter/coupler device
120 Optical splitter/coupler device
130 Monitoring device
132 Measurement unit
133 Acquisition unit
134 Storage unit
135 Range determination unit
136 Determination unit
137 Restriction unit
138 Spectrum analyzer
139 Dithering instruction unit
140 Optical cross connect device
150 Blocking unit
160 Optical splitter/coupler device
170 Separation device
217 Separation unit
20 User device
50 Control unit
51 Processor
53 Main memory
55 Storage
57 Interface

1. A monitoring device that monitors a path through which light output from a plurality of devices flows, the monitoring device comprising:
at least one processor adapted to function as:
a determination unit that determines whether non-compliant light that does not satisfy a predetermined criterion is included in the light flowing through the path; and
a restriction unit that controls that the light does not flow through the path when the non-compliant light is included in the light.

2. The monitoring device according to claim 1, wherein
the restriction unit controls that light from some of the plurality of devices does not flow and light from other devices flows, and
the determination unit specifies the device that outputs the non-compliant light on the basis of an intensity of the light when the control is performed that the light from some of the devices does not flow and the light from the other devices flows.

3. The monitoring device according to claim 1, wherein
the restriction unit individually outputs a restriction instruction of output of the light or a restriction release instruction of output of the light to a device subject to determination of the non-compliant light by the determination unit among the plurality of devices.

4. The monitoring device according to claim 1, wherein the at least one processor adapted to further function as:
a modulation instruction unit that outputs a modulation instruction to modulate the light in respective different patterns to the plurality of devices, wherein
the determination unit specifies a device that outputs non-compliant light on the basis of an intensity of each of signal components of each of patterns separated from the light, and
the restriction unit controls that the light from the device that outputs non-compliant light among the plurality of devices does not flow.

5. The monitoring device according to claim 1, wherein the at least one processor adapted to further function as:
a blocking unit configured to be switchable between passage and blocking of the light is provided on the path, wherein
the restriction unit outputs an instruction to block the light or an instruction to pass the light to the blocking unit corresponding to a device subject to determination of the non-compliant light by the determination unit among the plurality of devices.

6. A monitoring method, comprising:
a step of determining whether non-compliant light that does not satisfy a predetermined criterion is included in light output from a plurality of devices, the light flowing through a path to be monitored; and
a step of controlling that the light does not flow through the path when the non-compliant light is included in the light.

7. A monitoring system, comprising:
the monitoring device according to claim 3; and
a plurality of devices that is connected to the path and restricts output of the light on the basis of the restriction instruction.

8. A communication system, comprising:
a path through which light output from a plurality of devices flows;
the monitoring device according to claim 1 that monitors the path; and
an optical cross connect device that routes and outputs the light flowing through the path to a port corresponding to a destination of the light.
